(19) United States
(12) Patent Application Publication
(10) Pub. No.: US 2007/0171836 A1
(43) Pub. Date: Jul. 26, 2007

(54) ESTIMATING SYSTEM, TERMINAL, ESTIMATING METHOD, AND PROGRAM

(75) Inventors: Hideo Yoshimi, Tokyo (JP); Nobuyuki Enomoto, Tokyo (JP); Chinryuu Sai, Tokyo (JP); Kazuo Takagi, Tokyo (JP); Atsushi Iwata, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/625,687

(22) Filed: Jan. 22, 2007

(30) Foreign Application Priority Data
Jan. 23, 2006 (JP) 2006-014472

(51) Int. Cl. H04J 1/16; H04J 3/14

(52) U.S. Cl. 370/250; 370/252

(57) ABSTRACT

An object of the present invention is to provide a technology capable of estimating header conversion applied in a network by collecting information required in the estimation, without introducing a special-purpose server directed to estimate header conversion applied in the network. The present invention provides a system for estimating information about apparatuses on a network using an error message or control message sent in response to a transmitted packet as stipulated by a communication protocol to estimate information about apparatuses on the network.

### BACKGROUND OF THE INVENTION

The present invention relates to a technology for estimating an environment of a network using an ICMP message, and particularly to a technology for estimating information about communication apparatuses connected to a network.

Information and communication networks such as local area networks (LAN) and the Internet are constructed by combining a variety of communication apparatuses.

First, an exemplary configuration of a network as shown in FIG. 1 is considered.

In FIG. 1, there are included a network 4 such as the Internet, NAT routers 2 and 6 for address translation, PC's 1 and 7 operated by a user, any given PC 5 on the Internet, and a router 3 for controlling routing of packets. The network 4 also includes routers 8-11 for controlling routing of packets.

The function of the components in FIG. 1 will now be described.

First, the function of the NAT router 2 will be described. (The following description also applies to the NAT router 6.)

A primary function of the NAT router 2 is an address translation (NAT: Network Address Translation) function. While it is a common practice to assign the PC 1 in a LAN with a private IP address, it is necessary to assign the PC 1 in a LAN with a global IP address to connect it to the network 4. To solve this problem, the NAT router 2 conducts address translation between a private IP address and a global IP address so that the PC 1 can connect to the network 4. Particularly, an IP source address of a packet transmitted by the PC 1 in the LAN is translated into a global IP address, and then the packet is transferred to the router 3. FIG. 2 shows the format of an IP header and a UDP header for reference.

The NAT router 2 may also support a NAPT (NAPT: Network Address Port Translation) function for, in addition to IP source address translation for packets transmitted by the PC 1 as described above, translating a source port number as well. NAPT is a similar technology to NAT except that it is characterized in additionally translating port numbers of TCP and UDP, as compared with NAT that only translates an IP address. Thus, one global IP address can accommodate a plurality of PC's having respective private IP addresses. For example, although in dialup connection, only one global IP address is given by the Internet service provider (ISP), a plurality of PC's in a LAN can be connected to the network 4 at the same time by using NAPT.

Next, the function of the router 3 will be described. (The following description also applies to the routers 8-11).

A primary function of the router 3 is a packet routing control function, and in addition to that, the router 3 also supports a priority control function. The priority control function is a technology such that when it is evident that packet loss will be brought about in a network due to converged traffic, an important packet is processed with a higher priority to prevent packet loss. For example, in FIG. 1, a packet may be lost in the network 4 due to converged traffic. When a packet is lost, there may arise a phenomenon that, for example, a response by an important communication service is delayed or a service is abnormally terminated. The priority control function is used for solving such problems and realizing a stable operation of important services.

A method of implementing priority control is exemplarily shown in FIG. 1; in the router 3, a congestive condition of the network is monitored and a ToS value of an incoming packet is modified. The ToS value has information written that determines quality of a packet such as priority thereof. In the routers in the network 4, priority control for packets is made according to the ToS value, whereby a high-quality communication service is provided to a specific flow.

In addition to the priority control function, a router also supports a packet fragmenting function. Ideally, the PC 1 transmitting an IP packet transmits a packet having a maximum size equal to a maximum transfer unit (MTU) of the network 4 to which it connects. In such an ideal environment, an IP packet transmitted by the PC 1 will arrive at a destination host with the size as the packet is generated; on the other hand, if a network having a smaller MTU is present on a communication path, as shown in FIG. 1 as between the routers 8 and 9, the IP packet is fragmented by a router at the border before being transmitted. This is the fragmenting function of a router. The router 8 that applies fragmentation sets one into a third bit in a flag field of the packet and zero into a flag field of the last packet. It also sets an offset value of data in a fragment offset field.

It is the last destination host that serves to recover an original form of the fragmented IP packets. The destination host reconstructs the original form of the fragmented IP packets based on information in the flag field and fragment offset field.

As described above, a NAT router and a router apply several kinds of conversion to a packet header, but the fact that such conversion has occurred is hidden from the sender PC 1. Thus, the sender PC 1 cannot know how the network is configured and what control functions are operating. A network that develops into a black box so that header conversion cannot be detected at the sender PC brings about various problems. These problems will be described hereinbelow.

First, a problem arising when the PC 1 cannot detect details of header conversion executed in the NAT router 2 will be described.

To communicate a packet between the PC 1 located inside the NAT router 2 and the PC 7 located inside the NAT router 6, it is necessary to transmit a packet destined for the global IP address and port number of each respective NAT router. In other words, it is necessary to acquire information about a NAT router attached to the communication partner beforehand; that is, information about the NAT router 2 is required to transmit a packet from the PC 7 to the PC 1, for example. A method of acquiring information on the NAT router 2 may be contemplated to involve receiving the information from the PC 1 that is connected to the NAT router 2; however, since details of address translation by the NAT router 2 are hidden from the PC 1 as described above, this method breaks down.

From the above, when address translation processing applied by a NAT router cannot be detected, a packet cannot be communicated between PC's connected to NAT routers.

Next, a problem arising when ToS value modification processing applied by a router cannot be detected at a PC will be described.

If a priority control function according to a ToS value is not operating in a network, it is difficult to use real-time applications such as IP phone or IP television that require an advanced priority control function. Although an effective method for determining whether priority control is operating or not involves detecting a change in a ToS value, this method breaks down because ToS value modification processing is hidden from a PC as described above.

From the above, unless ToS value modification processing applied by a router can be detected, whether an application is available or not cannot be known beforehand.

Next, a problem arising when fragmentation processing applied by a router cannot be detected at a PC will be described.

Although packet fragmentation does not hamper communication per se, efficiency in transfer may be degraded. For example, in an environment having an MTU of 1000 bytes between the routers 8 and 9 in the network 4 as shown in FIG. 1, when a packet of 1500 bytes is transmitted from the PC 1, data of 1500 bytes is fragmented into two data fragments having 1000 bytes and 500 bytes at the router 8. Such fragmentation not only requires fragmentation processing at the router 8 but also requires processing on two packets, instead of one packet, at the router 9. Consequently, in addition to an increased load on the routers, the network 4 is more loaded because if either one of two fragmented packets is broken both the packets must be discarded. A method to prevent such fragmentation may be contemplated to involve checking at the PC 1 a packet size that will not result in fragmentation, and transmitting a packet having an appropriate size from the PC 1; however, since occurrence of fragmentation is hidden from the PC 1, this method breaks down.

From the above, unless fragmentation at the router can be detected, degradation of efficiency in packet transfer cannot be prevented.

As described above, various problems arise when a sender PC cannot detect header conversion made on a communication path.

Exemplary methods for solving the problems are described in Non-patent Document 1 and Patent Document 1.

The method described in Non-patent Document 1 involves providing a special-purpose server 312 on the Internet such as a network 304, as shown in FIG. 3. A PC 301 of FIG. 3 transmits a packet to the special-purpose server 312. The special-purpose server 312 picks up header information of the packet received from the PC 301, and notifies it to the PC 301 in return. At that time, the information notified from the special-purpose server 312 to the PC 301 in return includes an IP address and a port number, as well as a ToS value and a flag field.

On the other hand, the PC 301 can detect whether header conversion has been made on a communication path with reference to the header information notified in return as described above and can know details of the header conversion. Moreover, the information on header conversion is used to address the aforementioned problems.

For example, as for address translation processing applied at a NAT router, according to the method of Non-patent Document 1, the PC 301 receives the IP address and port number of the NAT router 302 from the special-purpose server 312, and then, the information on the NAT router 302 is notified to the PC 307, thereby enabling a packet to be transmitted from the PC 307 to the PC 301.

As for ToS value modification processing applied at a router, according to the method of Non-patent Document 1, the PC 301 receives a ToS value of a packet from the special-purpose server 312, whereby it can know whether a priority control function is operating in the network.

As for fragmentation processing applied at a router, according to the method of Non-patent Document 1, the PC 301 receives a fragment field of a packet from the special-purpose server 312, whereby it can detect a packet size that will result in no fragmentation, to maximize efficiency in packet transfer. [Non-patent Document 1] J. Rosenberg, and three other authors, “RFC3489: STUN Technology” [online], [searched as of Sep. 1, 2004];

URL: http://www.faqs.org/rfcs/rfc3489.html.

[Patent Document 1] Japanese Patent Application Laid Open No. 2005-102196

### SUMMARY OF THE INVENTION

Now problems of the method described in Non-patent Document 1 will be described.

Since in the method described in Non-patent Document 1, the special-purpose server 312 must be provided in the Internet, cumbersome maintenance/operation works for the special-purpose server 312 are required.

Moreover, to prevent the special-purpose server 312 from attack by malicious third parties on the Internet, cumbersome works for keeping the security level of the special-purpose server 312 are required.

Furthermore, to prevent a steep increase of a processing load on the special-purpose server 312, cumbersome works for distributing the load on the special-purpose server 312 are required.

The present invention has been made to solve all the problems, and its object is to provide a method of estimating header conversion made on a communication path without introducing such a special-purpose server 312.

A first invention for solving the aforementioned problems is:

an estimating system for estimating information about apparatuses on a network, characterized in comprising:

responding means of responding to an incoming information-collecting packet to send a control message in return; and

estimating means of estimating information about apparatuses on said network based on the control message from said responding means.

A second invention for solving the aforementioned problems is the first invention, characterized in that:

said responding means is means of responding to an information-collecting packet destined for a port number that is not in a standby status to send a control message indicating unreachable in return.

A third invention for solving the aforementioned problems is the first or second invention, characterized in that:

said responding means is means of sending a control message in return in which said information-collecting packet is stored in a data portion of a header of the message.

A fourth invention for solving the aforementioned problems is any one of the first-third inventions, characterized in that:

said responding means is means of responding to an information-collecting packet having information indicating a number of apparatuses that allow said information-collecting packet to pass being zero to send a control message in return indicating that said information-collecting packet is discarded.

A fifth invention for solving the aforementioned problems is any one of the first-fourth inventions, characterized in that:

said estimating means is means of estimating based on information indicating quality.

A sixth invention for solving the aforementioned problems is any one of the first-fourth inventions, characterized in that:

said estimating means is means of estimating based on information indicating that said information-collecting packet is fragmented.

A seventh invention for solving the aforementioned problems is any one of the first-fourth inventions, characterized in that:

said estimating means is means of estimating based on a checksum value.

An eighth invention for solving the aforementioned problems is the seventh invention, characterized in that:

said estimating means is means of estimating information about an apparatus that has modified an IP source address in a data portion of said control message based on an IP checksum value, and estimating information about an apparatus that has modified a source port number in the data portion of said control message based on a UDP checksum value or a TCP checksum value.

A ninth invention for solving the aforementioned problem is the eighth invention, characterized in that:

said estimating means is means of estimating information about an apparatus that has modified an IP source address in the data portion of said control message based on a UDP checksum value or a TCP checksum value.

A tenth invention for solving the aforementioned problem is the seventh or eighth invention, characterized in that:

said estimating means is means of estimating taking account of a result of a route tracing test for a network.

An eleventh invention for solving the aforementioned problems is the tenth invention, characterized in that:

said route tracing test is a survey test achieved by transmitting a plurality of information-collecting packets having mutually different numeric values in information indicating the number of apparatuses that allow passage.

A twelfth invention for solving the aforementioned problems is the tenth or eleventh invention, characterized in that:

said route tracing test is a test for surveying the number of previously estimated apparatuses which are passed to reach a terminal.

A thirteenth invention for solving the aforementioned problems is any one of the tenth-twelfth inventions, characterized in that:

said route tracing test is a test for surveying the number of apparatuses that have been passed to reach an apparatus at a position of changeover between a private IP address and a global IP address.

A fourteenth invention for solving the aforementioned problems is any one of the first-thirteenth inventions, characterized in that:

said estimating means is means of notifying a result of estimation to a terminal on said network.

A fifteenth invention for solving the aforementioned problems is the fourteenth invention, characterized in that:

said estimating means is configured to store, on receipt of a result of estimation from another terminal on said network, said result of estimation.

A sixteenth invention for solving the aforementioned problems is the fourteenth or fifteenth invention, characterized in that:

said estimating means is means of estimating regularity in assignment processing for port numbers of computers on said network based on a plurality of results of estimation.

A seventeenth invention for solving the aforementioned problems is any one of the fourteenth-sixteenth inventions, characterized in that:

said estimating means is configured to notify said results of estimation to a communication partner via a mail or phone.

An eighteenth invention for solving the aforementioned problems is any one of the first-seventeenth inventions, characterized in that:

said estimating means is means of setting information indicating the number of apparatuses that allow said information-collecting packet to pass to a value such that the information will not reach a destination acquired based on said result of estimation, transmitting a SYN packet to said destination, and notifying a sequence number of the SYN packet to said destination.

A nineteenth invention for solving the aforementioned problems is the eighteenth invention, characterized in that:

said estimating means is means of transmitting, on receipt of the sequence number of said transmitted SYN packet, a response confirmation packet taking account of the sequence number.

A twentieth invention for solving the aforementioned problems is:

a system for estimating information about apparatuses on a network, characterized in that:

an error message or control message stipulated by a communication protocol is used to estimate information about apparatuses on said network.

A twenty-first invention for solving the aforementioned problems is:

a terminal, characterized in comprising:

means of transmitting an information-collecting packet;

estimating means of estimating information about apparatuses on a network based on a control message transmitted in response to said information-collecting packet.

A twenty-second invention for solving the aforementioned problems is:

an estimating method of estimating information about apparatuses on a network, characterized in comprising:

a responding step of responding to an incoming information-collecting packet to send a control message in return;

a deciding step of deciding whether a received message is a control message sent in return in response to said information-collecting packet; and

an estimating step of, if a received message is decided to be a control message sent in return in response to said information-collecting packet as a result of said decision, estimating information about apparatuses on said network based on said control message.

A twenty-third invention for solving the aforementioned problems is the twenty-second invention, characterized in that:

said responding step is a step of responding to an information-collecting packet destined for a port number that is not in a standby status to send a control message indicating unreachable in return.

A twenty-fourth invention for solving the aforementioned problems is the twenty-second or twenty-third invention, characterized in that:

said responding step is a step of sending a control message in return in which said information-collecting packet is stored in a data portion of a header of the message.

A twenty-fifth invention for solving the aforementioned problems is any one of the twenty-second-twenty-fourth inventions, characterized in that:

said responding step is a step of responding to an information-collecting packet having information indicating a number of apparatuses that allow said information-collecting packet to pass being zero to send a control message in return indicating that said information-collecting packet is discarded.

A twenty-sixth invention for solving the aforementioned problems is any one of the twenty-second-twenty-fifth inventions, characterized in that:

said estimating step is a step of estimating based on information indicating quality.

A twenty-seventh invention for solving the aforementioned problems is any one of the twenty-second-twenty-fifth inventions, characterized in that:

said estimating step is a step of estimating based on information indicating that said information-collecting packet is fragmented.

A twenty-eighth invention for solving the aforementioned problems is any one of the twenty-second-twenty-fifth inventions, characterized in that:

said estimating step is a step of estimating based on a checksum value.

A twenty-ninth invention for solving the aforementioned problems is the twenty-eighth invention, characterized in that:

said estimating step further comprises the steps of:
estimating information about an apparatus that has modified an IP source address in a data portion of said control message based on an IP checksum value; and
estimating information about an apparatus that has modified a source port number or an IP address in the data portion of said control message based on a UDP checksum value or a TCP checksum value.

A thirtieth invention for solving the aforementioned problems is the twenty-eighth or twenty-ninth invention, characterized in that:

said estimating step further comprises:
a route tracing execution step of executing a route tracing test for a network; and
a detailed information estimating step of estimating information about apparatuses taking account of a result of said execution.

A thirty-first invention for solving the aforementioned problems is the thirtieth invention, characterized in that:

said route tracing execution step is a step of transmitting a plurality of information-collecting packets having mutually different numeric values in the information indicating the number of apparatuses that allow passage.

A thirty-second invention for solving the aforementioned problems is the thirtieth or thirty-first invention, characterized in that:

said route tracing execution step is a step of surveying the number of a previously estimated apparatuses which are passed to reach an apparatus.

A thirty-third invention for solving the aforementioned problems is any one of the thirtieth-thirty-second inventions, characterized in that:

said route tracing execution step is a step of surveying the number of apparatuses that have been passed to reach an apparatus at a position of changeover between a private IP address and a global IP address.

A thirty-fourth invention for solving the aforementioned problems is any one of the twenty-second-thirty-third inventions, characterized in that:

said estimating step further comprises the step of notifying a result of estimation to a terminal on said network.

A thirty-fifth invention for solving the aforementioned problems is the thirty-fourth invention, characterized in that:

said estimating step further comprises the step of, on receipt of a result of estimation from another terminal on said network, storing said result of estimation.

A thirty-sixth invention for solving the aforementioned problems is the thirty-fourth or thirty-fifth invention, characterized in that:

said estimating step is a step of estimating regularity in assignment processing for port numbers of computers on said network based on a plurality of results of estimation.

A thirty-seventh invention for solving the aforementioned problems is any one of the thirty-fourth-thirty-sixth inventions, characterized in that:

said estimating step further comprises an estimating step of notifying said results of estimation to a terminal that serves as a communication partner via a mail or phone.

A thirty-eighth invention for solving the aforementioned problems is any one of the twenty-second-thirty-seventh inventions, characterized in that:

said estimating step further comprises the steps of: setting information indicating the number of apparatuses that allow said information-collecting packet to pass to a value such that the information will not reach a destination acquired based on said result of estimation, transmitting a SYN packet to said destination, and notifying a sequence number of the SYN packet to said destination.

A thirty-ninth invention for solving the aforementioned problems is the thirty-eighth invention, characterized in that:

said estimating step further comprises the steps of:
receiving the sequence number of said transmitted SYN packet; and
transmitting a response confirmation packet taking account of said received sequence number.

A fortieth invention for solving the aforementioned problems is:

a program for an estimating system for estimating information about apparatuses on a network, characterized in causing said system to function as:

responding means of responding to an incoming information-collecting packet to send a control message; and

estimating means of estimating information about apparatuses on said network based on the control message from said responding means.

A forty-first invention for solving the aforementioned problems is:

a program for a terminal, characterized in causing said terminal to function as:

deciding means of deciding whether a received message is a control message sent in return in response to an information-collecting packet; and

estimating means of, if a received message is decided to be a control message sent in return in response to said information-collecting packet as a result of said decision, estimating information about apparatuses on said network based on said control message.

A forty-second invention for solving the aforementioned problems is:

a program for a system for estimating information about apparatuses on a network, characterized in causing said system to function as:

means of estimating information about apparatuses on said network using an error message or control message stipulated by a communication protocol.

The first estimating system of the present invention has a packet transmitting section for transmitting a packet to a port number of a PC on a network that is not in a standby status, a packet receiving section for receiving an ICMP port-unreachable message sent in return by the PC on the network, and an analyzing section for detecting header conversion applied in the network with reference to a checksum in the received ICMP port-unreachable message. The first estimating system of the present invention adopts such a configuration, in which header conversion is estimated based on a checksum in an ICMP port-unreachable message sent in return by a PC on a network, whereby details of header conversion made at a NAT router can be known without introducing a special-purpose server. For this reason, the object of the present invention is attained.

The second estimating system of the present invention has modified processing executed by the analyzing section in the first estimating system of the present invention. The analyzing section in the second estimating system of the present invention performs a route tracing test for a network, in addition to the processing by the analyzing section in the first estimating system of the present invention, to thereby improve accuracy in estimation for header conversion. The second estimating system of the present invention adopts such a configuration, in which a result of a route tracing test for a network is incorporated to estimate header conversion, whereby details of header conversion can be accurately known even if they are not completely narrowed by the first estimating system of the present invention. For this reason, the object of the present invention is attained.

The third estimating system of the present invention has modified processing executed by the analyzing section, packet transmitting section, and packet receiving section in the first estimating system of the present invention. The third estimating system of the present invention has a packet transmitting section for transmitting a packet whose TTL is set to a small value to a PC on a network, a packet receiving section for receiving an ICMP Time Exceeded message sent in return by a router on the network, and an analyzing section for detecting header conversion applied in the network with reference to a checksum in the received ICMP Time Exceeded message. The third estimating system of the present invention adopts such a configuration, in which header conversion is estimated based on a checksum in an ICMP Time Exceeded message sent in return by a router on a network, whereby even if an ICMP port-unreachable message is discarded in the network, details of header conversion made at a NAT router can be known without introducing a special-purpose server. For this reason, the object of the present invention is attained.

The fourth estimating system of the present invention has modified processing executed by the analyzing section, packet transmitting section, and packet receiving section in the third estimating system of the present invention. The fourth estimating system of the present invention has a packet transmitting section for transmitting a packet whose TTL is set to a small value to a PC on a network, a packet receiving section for receiving an ICMP Time Exceeded message sent in return by a router on the network, and an analyzing section for detecting header conversion applied in the network with reference to a checksum in the received ICMP Time Exceeded message. The fourth estimating system of the present invention adopts such a configuration, in which even if an IP checksum in an ICMP Time Exceeded message is modified into a correct value at a NAT router, details of header conversion made at a NAT router can be known based on a UDP checksum in an ICMP Time Exceeded message without introducing a special-purpose server. For this reason, the object of the present invention is attained.

The fifth estimating system of the present invention has modified processing executed by the analyzing section, packet transmitting section, and packet receiving section in the third estimating system of the present invention, and further comprises an application section. The fifth estimating system of the present invention has a packet transmitting section for transmitting a packet whose TTL is set to a small value to a PC on a network, a packet receiving section for receiving an ICMP Time Exceeded message sent in return by a router on the network, an analyzing section for detecting header conversion applied in the network with reference to a checksum in the received ICMP Time Exceeded message and notifying a result of the detection to a PC that serves as a communication partner, and an application section for communicating packets with the PC that serves as a communication partner. The fifth estimating system of the present invention adopts such a configuration, in which even if a PC and its partner PC are located downstream of respective NAT routers, details of header conversion made at a NAT router can be known with reference to a checksum in an ICMP Time Exceeded message and information required in communicating packets between PC's can be known by notifying the information to each other without introducing a special-purpose server. For this reason, the object of the present invention is attained.

The sixth estimating system of the present invention has modified processing executed by the analyzing section in the third estimating system of the present invention. The analyzing section in the sixth estimating system of the present invention detects a change in a ToS field made in a network with reference to the received ICMP Time Exceeded message. The sixth estimating system of the present invention adopts such a configuration, in which a change in ToS field is estimated based on an ICMP Time Exceeded message sent in return by a router on a network, whereby whether a priority control function is operating in a network can be known without introducing a special-purpose server. For this reason, the object of the present invention is attained.

The seventh estimating system of the present invention has modified processing executed by the analyzing section in the third estimating system of the present invention. The seventh estimating system of the present invention detects a change in a fragment field made in a network with reference to the received ICMP Time Exceeded message. The seventh estimating system of the present invention adopts such a configuration, in which a change in a fragment field is estimated based on an ICMP Time Exceeded message sent in return by a router on a network, whereby whether fragmentation is brought about in a network can be known without introducing a special-purpose server. For this reason, the object of the present invention is attained.

The eighth estimating system of the present invention has modified processing executed by the analyzing section, packet transmitting section, and packet receiving section in the fifth estimating system of the present invention, and additionally comprises a TCP section 4008. The eighth estimating system of the present invention adopts such a configuration, in which three-way handshake processing with a communication partner is performed, whereby information required in communicating TCP packets between PC's can be known without introducing a special-purpose server. For this reason, the object of the present invention is attained.

According to the present invention, occurrence of header conversion in a network can be estimated by sophisticatedly using an ICMP in an existing standard communication protocol with reference to the checksum value in an ICMP header without introducing a special-purpose server on the Internet, and thus, the object of the present invention is attained.

Thus, cost for maintenance/operation of a special-purpose server is eliminated, and no special-purpose server is attacked by external unauthenticated users, thus assuring safety. Moreover, even if the number of PC's in a LAN is increased, UDP packets may be destined for different PC's to avoid an increase of a load on the PC 405 for sending an ICMP packet in return, thus offering excellent scalability.

For explaining a mode by which the aforementioned features and advantages of the present invention can be attained, specific embodiments will be described hereinbelow with reference to the accompanying drawings. It should be understood that these drawings and explanation merely illustrate representative embodiments of the present invention and do not limit the scope thereof, and the present invention will be described and explained more clearly and in more detail with reference to the accompanying drawings.

### BRIEF DESCRIPTION OF THE DRAWINGS

This and other objects, features and advantages of the present invention will become more apparent upon a reading of the following detailed description and drawings, in which:

FIG. 1 is a diagram for explaining a network;

FIG. 2 is a diagram for explaining headers in a packet;

FIG. 3 is a network configuration diagram in a conventional technique;

FIG. 4 is a network configuration diagram for explaining a first embodiment of the present invention;

FIG. 5 is a block diagram of a terminal in the first embodiment of the present invention;

FIG. 6 is a flow chart for explaining a transmitting operation at an analyzing section in the first embodiment of the present invention;

FIG. 7 is a flow chart for explaining a transmitting operation at a packet transmitting section in the first embodiment of the present invention;

FIG. 8 is a flow chart for explaining a transmitting operation at a UDP section in the first embodiment of the present invention;

FIG. 9 is a flow chart for explaining a transmitting operation at an IP section in the first embodiment of the present invention;

FIG. 10 is a flow chart for explaining a transmitting operation at a MAC section in the first embodiment of the present invention;

FIG. 11 is a diagram for explaining modification in a packet header in the first embodiment of the present invention;

FIG. 12 is a flow chart for explaining a receiving operation at the MAC section in the first embodiment of the present invention;

FIG. 13 is a flow chart for explaining a receiving operation at the IP section in the first embodiment of the present invention;

FIG. 14 is a flow chart for explaining a receiving operation at the packet receiving section in the first embodiment of the present invention;

FIG. 15 is a flow chart for explaining a receiving operation at the analyzing section in the first embodiment of the present invention;

FIG. 16 is a flow chart for explaining an operation of IP address estimation processing at the analyzing section in the first embodiment of the present invention;

FIG. 17 is a flow chart for explaining an operation of port estimation processing at the analyzing section in the first embodiment of the present invention;

FIG. 18 is a diagram for explaining a pseudo-header of UDP;

FIG. 19 is a block diagram of a terminal in a second embodiment of the present invention;

FIG. 20 is a flow chart for explaining a transmitting operation at an analyzing section in the second embodiment of the present invention;

FIG. 21 is a flow chart for explaining a transmitting operation at a packet transmitting section in the second embodiment of the present invention;

FIG. 22 is a flow chart for explaining a transmitting operation at a MAC section in the second embodiment of the present invention;

FIG. 23 is a flow chart for explaining a receiving operation at the MAC section in the second embodiment of the present invention;

FIG. 24 is a flow chart for explaining a receiving operation at the packet receiving section in the second embodiment of in the present invention;

FIG. 25 is a flow chart for explaining a receiving operation at the analyzing section in the second embodiment of the present invention;

FIG. 26 is a block diagram of a terminal in a third embodiment of the present invention;

FIG. 27 is a flow chart for explaining a transmitting operation at an analyzing section in the third embodiment of the present invention;

FIG. 28 is a flow chart for explaining a transmitting operation at a packet transmitting section in the third embodiment of the present invention;

FIG. 29 is a block diagram of a terminal in a fourth embodiment of the present invention;

FIG. 30 is a diagram for explaining modification in a packet header in the fourth embodiment of the present invention;

FIG. 31 is a block diagram of a terminal in a fifth embodiment of the present invention;

FIG. 32 is a flow chart for explaining a transmitting operation at a packet transmitting section in the fifth embodiment of the present invention;

FIG. 33 is a flow chart for explaining exchange of information about header conversion in the fifth embodiment of the present invention;

FIG. 34 is a diagram for explaining a network configuration in a sixth embodiment of the present invention;

FIG. 35 is a block diagram of a terminal in the sixth embodiment of the present invention;

FIG. 36 is a diagram for explaining modification in a packet header in the sixth embodiment of the present invention;

FIG. 37 is a diagram for explaining a network configuration in a seventh embodiment of the present invention;

FIG. 38 is a block diagram of a terminal in the seventh embodiment of the present invention;

FIG. 39 is a diagram for explaining modification in a packet header in the seventh embodiment of the present invention;

FIG. 40 is a block diagram of a terminal in an eighth embodiment of the present invention.

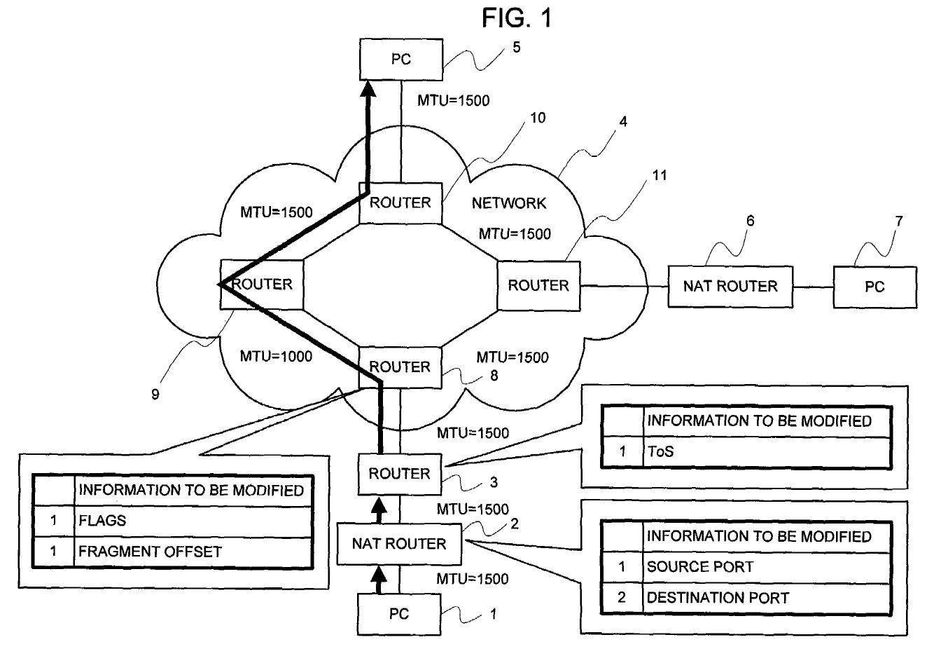

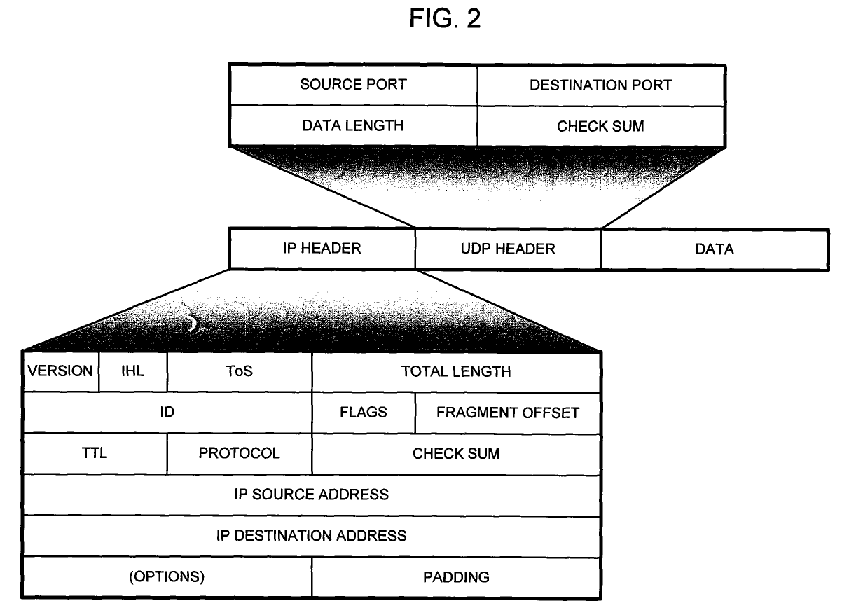

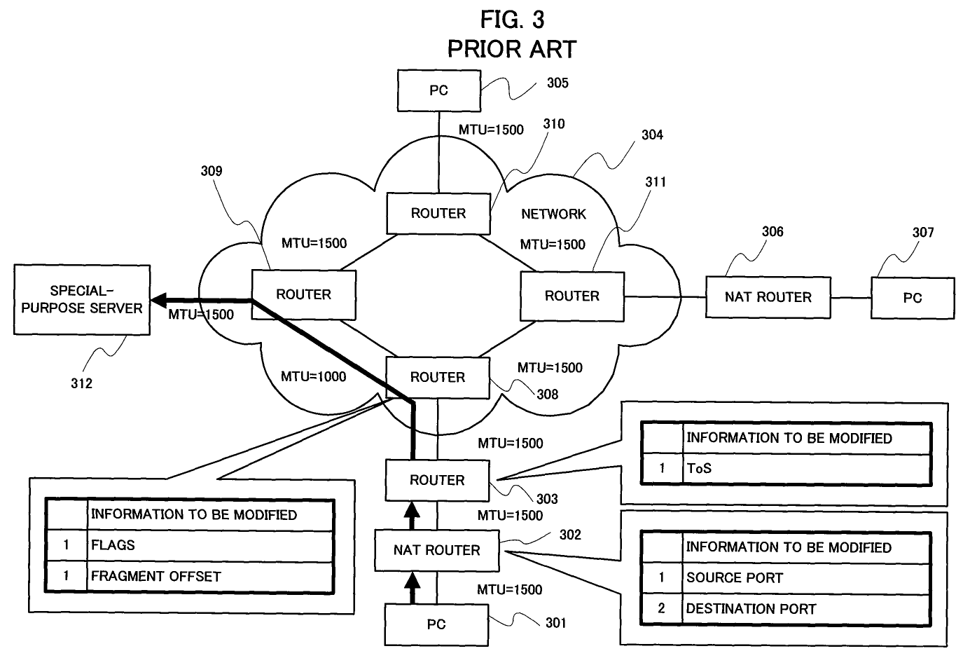

### DESCRIPTION OF THE EMBODIMENTS

Now a first embodiment for practicing the present invention will be described in detail with reference to the accompanying drawings.

### <Configuration>

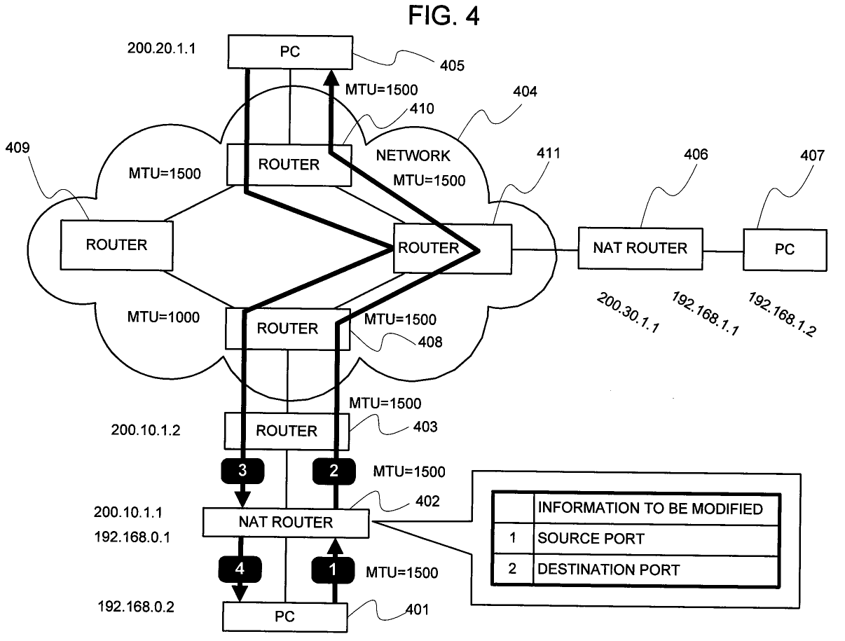

Referring to FIG. 4, the first embodiment of the present invention comprises a network 404 such as the Internet, NAT routers 402 and 406 for address translation, PC's 401 and 407 operated by a user, any given PC 405 on the Internet, and a router 403 for controlling routing of packets.

The network 4 also comprises routers 408-411 for controlling routing of packets.

The PC 405 does not support any special function such as those of the special-purpose server 312 as described in Non-patent Document 1, and it may be any given common terminal.

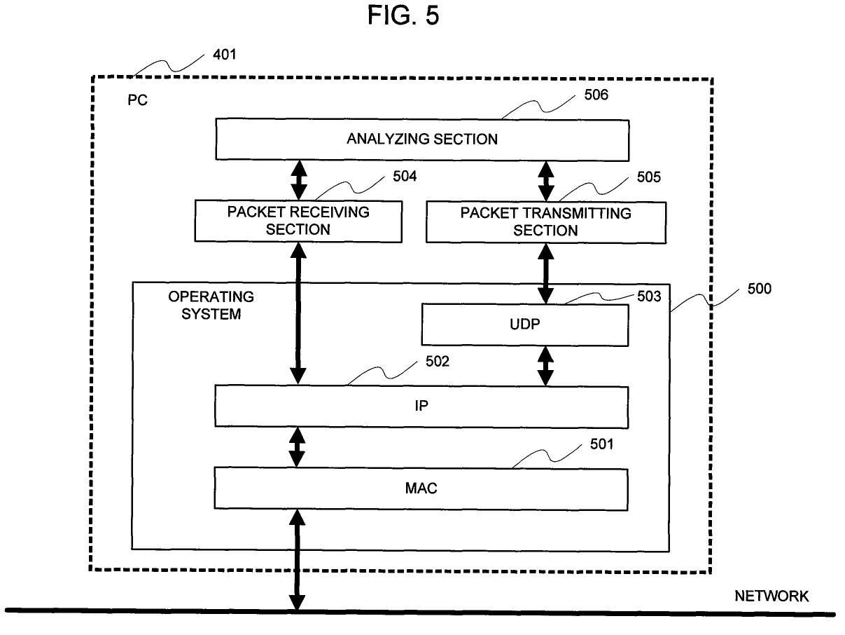

FIG. 5 shows the internal configuration of the PC 401.

As shown in FIG. 5, the PC 401 comprises an analyzing section 506, a packet receiving section 504, a packet transmitting section 505, and an operating system 500. The operating system 500 here comprises a UDP section 503, an IP section 502, and a MAC section 501.

The analyzing section 506 commands the packet transmitting section 505 to transmit a UDP packet for collecting information required to detect details of header conversion applied in the network, to a specified IP address and port number. The analyzing section 506 also detects details of header conversion applied in the network with reference to header information in an ICMP packet passed by the packet receiving section 504. It should be noted that the UDP packet may be a dummy packet.

On receipt of the command to transmit a UDP packet from the analyzing section 506, the packet transmitting section 505 passes data to the UDP section 503 for performing processing of transmitting a UDP packet to a destination specified by the analyzing section 506.

The packet receiving section 504 receives an ICMP packet from the IP section 502, and passes data of the packet to the analyzing section 504.

The UDP section 503 appends a UDP header to the data passed by the packet transmitting section 505, and then passes it to the IP section 506.

The IP section 502 appends an IP header to the data passed by the UDP section 503, and then passes it to the MAC section 501.

The IP section 502 also decides, on receipt of data from the MAC section 501, whether the data represents a data portion of an ICMP packet transmitted in response to a UDP packet, and if the data is decided to represent an ICMP packet transmitted in response to a UDP packet from the result of the decision, it is passed to the packet receiving section 504.

The MAC section 501 appends a MAC header to the data passed by the IP section 502, and then transmits it to a transmission path. The MAC section 501 also removes, on receipt of data from the transmission path, a MAC header therefrom, and then passes it to the IP section 502.

It should be noted that it is a common practice to use a standard TCP/IP function supported by the operating system 500 versatilely in the UDP section 503, IP section 502, and MAC section 501.

### <Operation>

Next, the operation of the embodiment for practicing the present invention will be described in detail with reference to FIGS. 4-18.

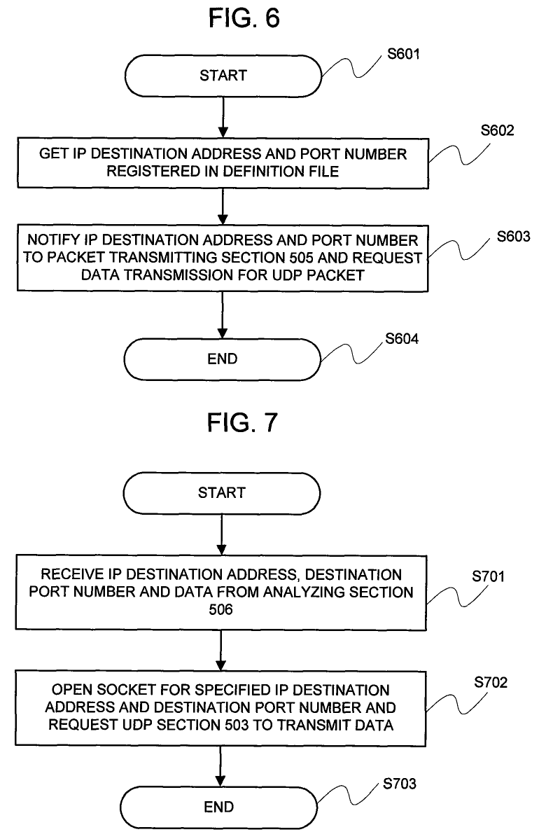

First, the analyzing section 506 in FIG. 5 transmits a UDP packet triggered by certain timing (Step S602 in FIG. 6).

The time at which a UDP packet is transmitted may be one or a combination of the following:

@ when commanded by a user interface or other applications;

@ when activating a service of the analyzing section;

@ when turning the power of a PC on;

@ at certain time intervals; and

@ when updating an IP address of a PC.

It should be understood that these times of transmission are merely listed by way of example. It would be obvious to those skilled in the art by reviewing the present description that a wide variety of kinds of times of transmission may be contemplated.

A destination of a UDP packet may be one or a combination of the following:

@ transmission is made toward an IP address and a port number specified by a user interface or other applications;

@ transmission is made toward an IP address and a port number predefined in a definition file or the like; and

@ transmission is made toward a randomly selected IP address and port number.

It should be understood that these destinations of a packet are merely listed by way of example. It would be obvious to those skilled in the art by reviewing the present description that a wide variety of destinations of a packet may be contemplated.

The following description of the operation will be made on a case in which a method is adopted to transmit a UDP packet from the PC 401 toward an IP address and a port number pre-registered in a definition file upon activation of a service of the analyzing section 506.

In the definition file here, it is assumed that an IP address of 200.20.1.1 and a port number of 9999 have been registered for the PC 405 of FIG. 4. The port number 9999 is a port number that is not in a standby status in the PC 405. Such a port number is defined as a destination so that an ICMP port-unreachable message will be sent in return by the PC 405.

The analyzing section 506 in FIG. 5 notifies the aforementioned IP address and port number to the packet transmitting section 505, and requests transmission of a UDP packet that is a packet for detecting details of header conversion applied in the network (Step S603 in FIG. 6).

On receipt of the request to transmit a UDP packet from the analyzing section 506 (Step S701 in FIG. 7), the packet transmitting section 505 opens a UDP socket destined for the specified IP address and port number, and passes the data to the UDP section 503 (Step S702 in FIG. 7).

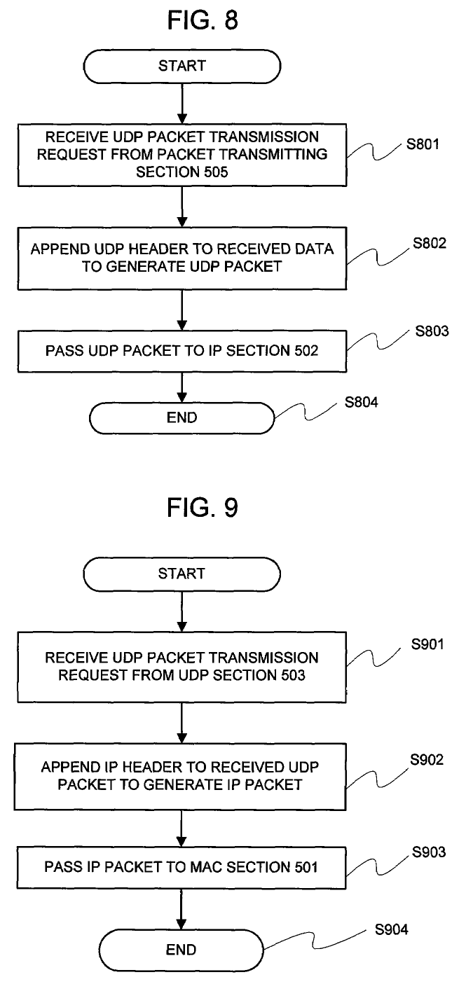

On receipt of the request to transmit data from the packet transmitting section 505 (Step S801 in FIG. 8), the UDP section 503 appends a UDP header to the data to generate a UDP packet (Step S802 in FIG. 8), and transfers it to the IP section 502 (Step S803 in FIG. 8).

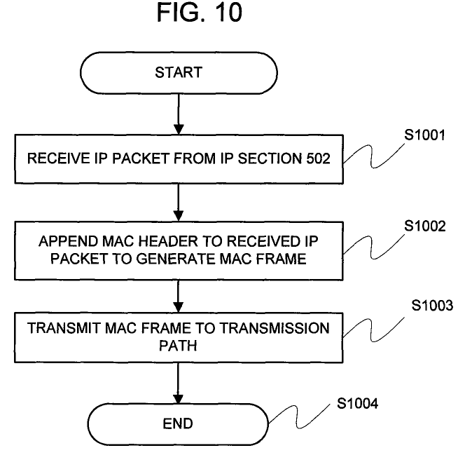

On receipt of the UDP packet from the UDP section 503, the IP section 502 appends an IP header thereto to generate an IP packet, and transfers it to the MAC section 501 (Step S903 in FIG. 9).

On receipt of the IP packet from the IP section 502 (Step S1001 in FIG. 10), the MAC section 501 appends a MAC header thereto to generate a MAC frame (Step S1002 in FIG. 10), and transmits it to the transmission path (Step S1003 in FIG. 10).

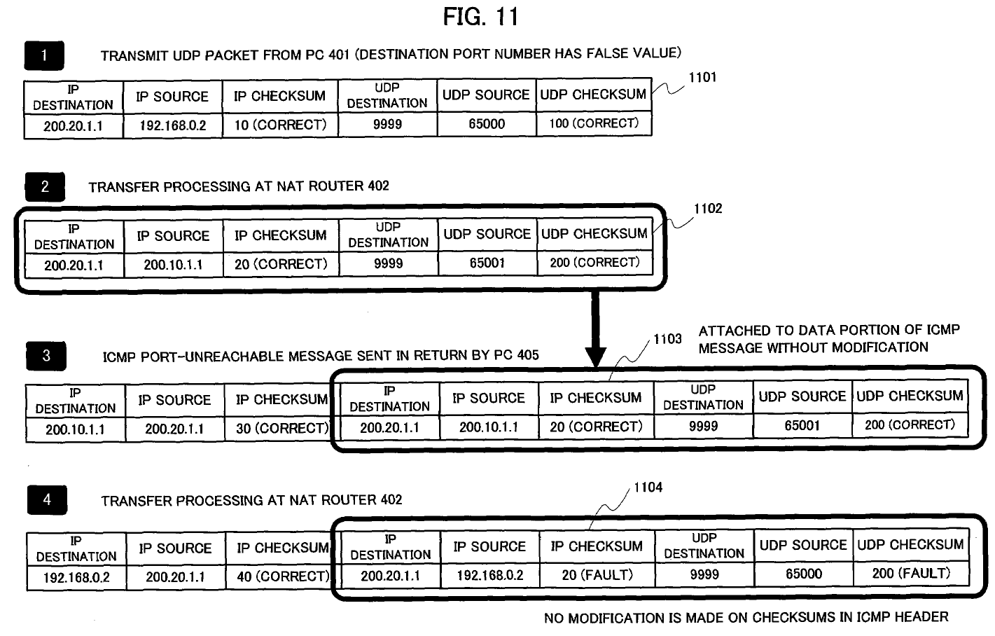

1101 in FIG. 11 shows the packet to be transmitted by the PC 401 according to the aforementioned processing.

The thus-transmitted data first undergoes modification of its IP source address and source port number at the NAT router 402 of FIG. 4. In this example, the IP source address is modified from 192.168.0.2 to 200.10.1.1, and the source port number is modified from 65000 to 65001. Moreover, the modification also entails recalculation of checksums of the IP header and of the UDP header. In this example, the checksum of the IP header is modified from 0x10 to 0x20, and that of the UDP header is modified from 0x100 to 0x200.

1102 in FIG. 11 shows the packet to be transmitted by the NAT router 402 according to the aforementioned processing.

The thus-modified packet passes through several routers to be delivered to the PC 405. For the sake of simplification, communication apparatuses except NAT routers are assumed not to convert the header in this example.

Although the PC 405 receives the packet, the destination port number, 9999, is not in a standby status. Thus, it sends an ICMP port-unreachable message in return to the NAT router 402 that was a sender of the packet.

The ICMP port-unreachable message is sent as an ICMP packet as shown in 1103 in FIG. 11, whose data portion is attached with the packet received earlier as shown in 1102 in FIG. 11 without modification.

1103 in FIG. 11 shows a packet to be transmitted by the PC 405 according to the aforementioned processing.

On receipt of the ICMP packet, the NAT router 402 modifies the IP destination address in the IP header of the ICMP packet from 200.10.1.1 to 192.168.0.2 for transferring it to the PC 401. The modification also entails recalculation of a checksum of the IP header and it is modified from 0x30 to 0x40.

The NAT router 402 also modifies the data portion of the ICMP header. Specifically, it modifies the IP source address from 200.10.1.1 to 192.168.0.2, and the source port number from 65001 to 65000. By thus modifying the data portion of the ICMP header as well, the packet can be made to still look like an ICMP port-unreachable message to the PC 401.

The NAT router 402, however, does not modify the checksums in the data portion of the ICMP header here, as shown in 1104 in FIG. 11, and hence, the checksums have false values.

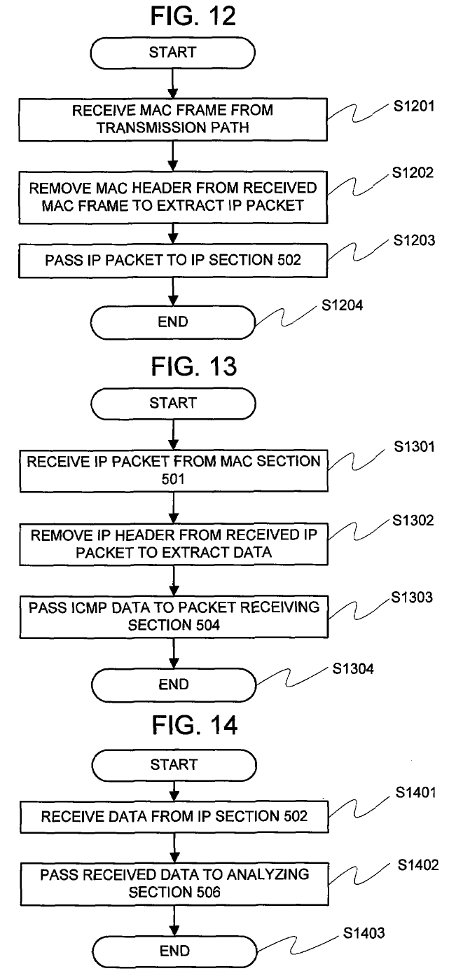

On receipt of the ICMP packet from the NAT router 402 (Step S1201 in FIG. 12), the PC 401 first removes the MAC header therefrom at the MAC section 501 (Step S1202 in FIG. 12), and then transfers it to the IP section 502 (Step S1203 in FIG. 12).

On receipt of the ICMP packet from the MAC section 501 (Step S1301 in FIG. 13), the IP section 502 removes the IP header therefrom (Step S1302 in FIG. 13), and then decides whether the data represents a data portion of an ICMP packet transmitted in response to a UDP packet. If it is decided to represent an ICMP packet transmitted in response to a UDP packet as a result of the decision, it is transferred to the packet receiving section 504 (Step S1303 in FIG. 13).

On receipt of the ICMP data from the IP section 502 (Step S1401 in FIG. 14), the packet receiving section 504 transfers the data portion of the ICMP header to the analyzing section 506 (Step S1402 in FIG. 14).

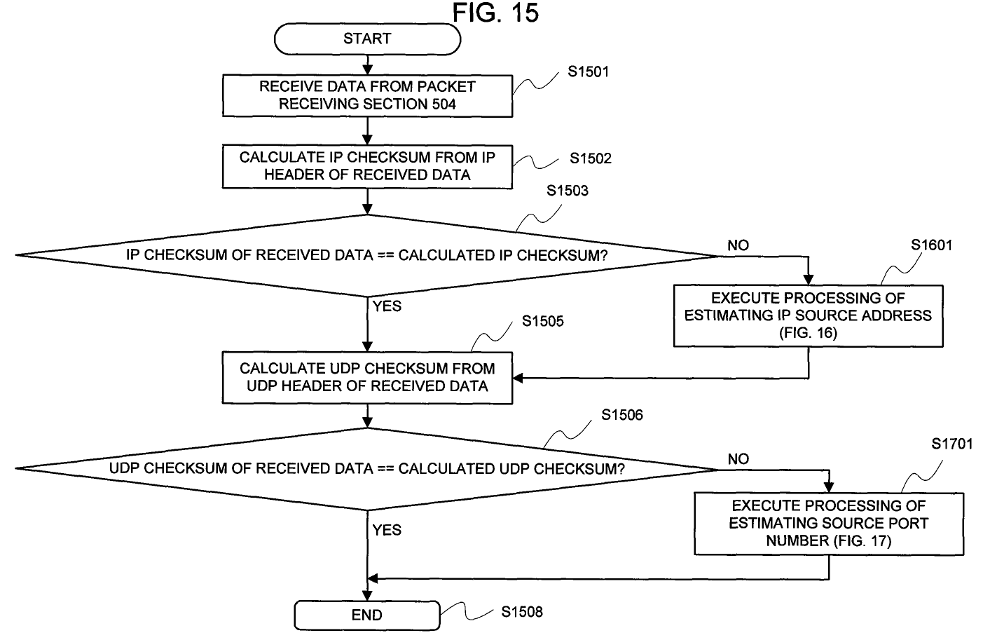

On receipt of the data portion from the packet receiving section 504 (Step S1501 in FIG. 15), the analyzing section 506 detects whether header conversion has been made in the network with reference to the status of its checksums. A method for this will be described hereinbelow.

First, the analyzing section 506 calculates an IP checksum from the IP header of the received data (Step S1502 in FIG. 15).

Next, a check is made as to whether the calculated IP checksum matches the IP checksum of the received data (Step S1503 in FIG. 15).

When IP address translation has been made at the NAT router 402, these checksums do not match, and thus occurrence of IP address translation can be detected.

If they do not match, it is considered that IP address translation has occurred, and the process goes to Step S1504 in FIG. 15 to estimate an IP address of the NAT router 402.

If they match, it is considered that no IP address translation has occurred, and the process goes to Step S1505 to calculate a UDP checksum from the UDP header of the received data.

Then, a check is made as to whether the calculated UDP checksum matches the UDP checksum of the received data (Step S1506 in FIG. 15).

When port number translation has been made at the NAT router 402, these checksums do not match, and thus occurrence of port number translation can be detected.

If they do not match, it is considered that port number translation has occurred, and the process goes to Step S1507 in FIG. 15 to estimate a port number of the NAT router 402.

If they match, it is considered that no port number translation has occurred, and the process is terminated.

Now both estimation processing when an IP checksum and a UDP checksum are false will be described hereinbelow.

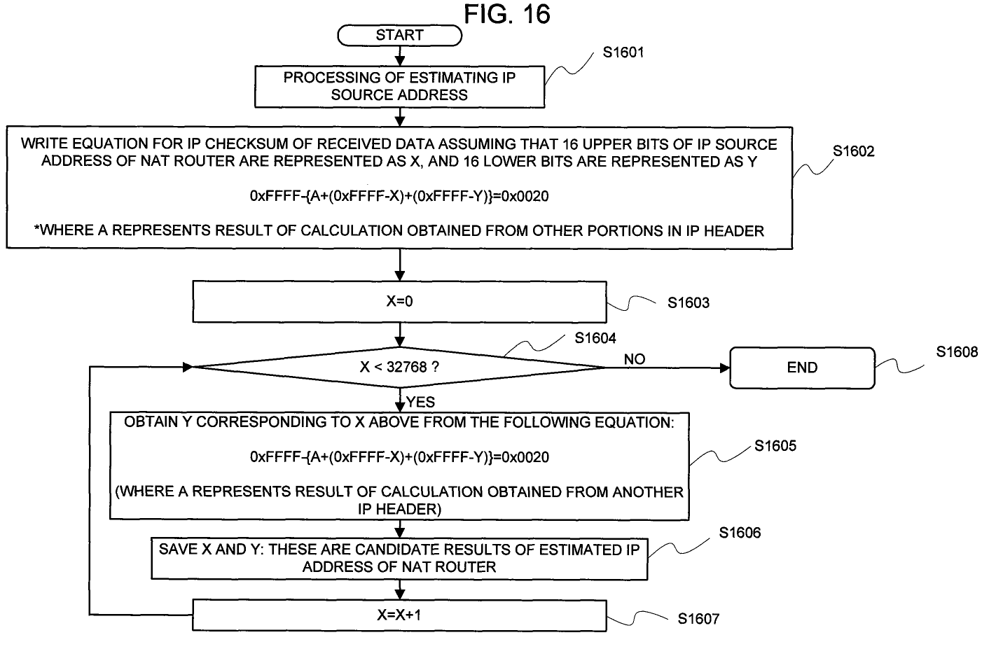

FIG. 16 shows IP address estimation processing executed at Step S1504 in FIG. 15.

The IP address contains 32 bits, and it is assumed at the analyzing section 506 that 16 upper bits of the IP address are represented as X, and 16 lower bits are represented as Y. After thus assuming the IP source address, an equation for an IP checksum of the received data is written (Step S1602 in FIG. 16).

As a supplemental explanation of the method of calculating an IP checksum, the IP checksum is obtained by dividing the IP header into 16-bit sub-portions, calculating a sum of the “complements of one” of each sub-portion, and then taking the “complement of one” of the sum as an IP checksum.

The analyzing section 506 performs a round-robin calculation for X and Y that satisfy the equation obtained at Step S1602 to estimate an IP address (Step S1604-S1607 in FIG. 16).

While the IP addresses that satisfy the equation include one that matches the IP address of the NAT, the number of combinations of X and Y that satisfy the equation is 32768. In the first embodiment, no mention will be made of a method of narrowing these candidate combinations.

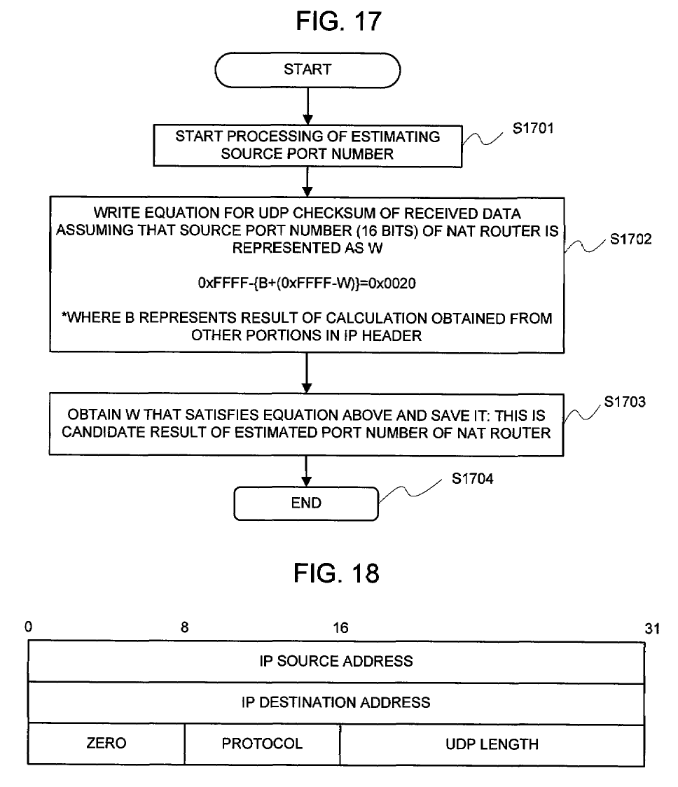

On the other hand, FIG. 17 shows port number estimation processing executed at Step S1507 in FIG. 15.

The port number contains 16 bits, and it is assumed at the analyzing section 506 that a resolved port number is W. After thus assuming the source port number, an equation for a UDP checksum of the received data is written (Step S1702 in FIG. 17).

As a supplemental explanation of the method of calculating a UDP checksum, the UDP checksum is calculated based on three portions: a “UDP header,” “payload data,” and a “UDP pseudo-header” that is shown in FIG. 18.

The “UDP pseudo-header” is an imaginary header for use only in calculating a checksum, and is not included in an actual UDP packet. The UDP checksum is obtained by dividing the whole header including the “UDP pseudo-header” into 16-bit sub-portions, calculating a sum of the “complements of one” of each sub-portion, and then taking the “complement of one” of the sum as a UDP checksum.

The analyzing section 506 calculates W that satisfies the equation obtained at Step S1702 to estimate a port number (Step S1703 in FIG. 17). At that time, the IP source address in the pseudo-header is assigned with the IP address found according to the aforementioned processing of FIG. 16.

The port numbers that satisfy the equation include one that matches the port number of the NAT.

Now it has been shown that by the aforementioned processing, an IP source address and a port number of a NAT can be estimated from a checksum in an ICMP header.

It should be noted that although the present embodiment explains a configuration in which a port number not in a standby status is specified as a destination and a packet is transmitted thereto so that an ICMP port-unreachable message (error message) is sent in return, the present invention is not limited thereto. Specifically, it suffices that a configuration is made such that the PC 401 transmits a packet to the PC 405, and in response to the packet, the PC 405 sends a control message in return to the PC 401. It should be noted that communication procedural messages (packets) stipulated in a communication protocol, such as an error (unreachable) message, control message and the like, are generically referred to herein as control messages (packets).

### <Effect>

Next, effects of the first embodiment in practicing the present invention will be described.

According to the first embodiment for practicing the present invention, header conversion applied in a network can be estimated without introducing a special-purpose sever on the Internet, by sophisticatedly using an ICMP in an existing standard communication protocol with reference to the checksum values in an ICMP header, and thus, the object of the present invention is attained.

Thus, cost for maintenance/operation of a special-purpose server is eliminated, and no special-purpose server is attacked by external unauthenticated users, thus assuring safety. Moreover, even if the number of PC's in a LAN is increased, UDP packets may be destined for different PC's to avoid an increase of a load on the PC 405 for sending an ICMP packet in return, thus offering excellent scalability.

Next, a second embodiment for practicing the present invention will be described in detail with reference to the accompanying drawings.

### <Configuration>

According to the first embodiment of the present invention, the IP address and port number of a NAT router are estimated with reference to checksums in an ICMP port-unreachable message. However, since the amount of information is different between an IP checksum and an IP address, estimation of an IP address from an IP checksum sometimes cannot isolate a unique IP address.

The reason of this is that an IP checksum has only 16 bits, i.e., 32768 combinations, whereas an IP address has 32 bits, i.e., as much as 32768×32768 combinations; hence, there are 32768 IP addresses for the same calculation result of the IP checksum.

From the above, according to the first embodiment of the present invention, an IP address and port number of a NAT router may not be isolated from a checksum, thus providing poor accuracy in estimation.

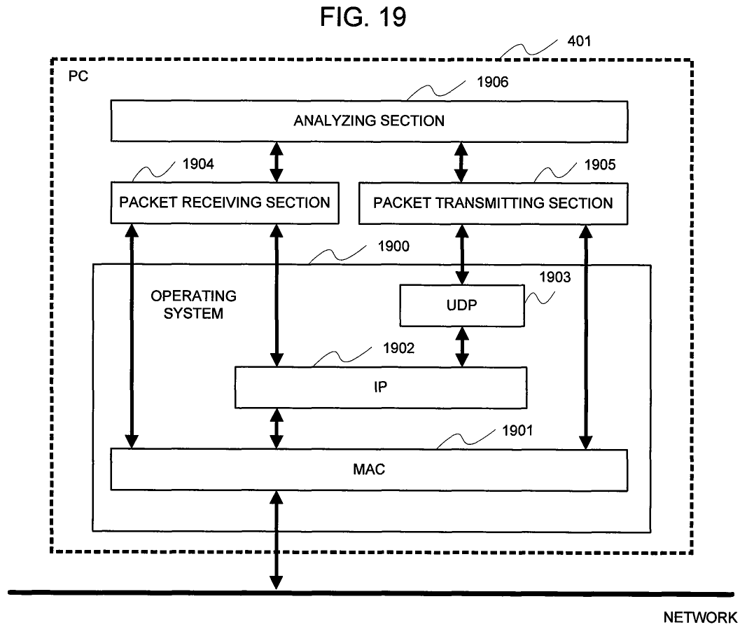

According to the second embodiment of the present invention, processing executed by the analyzing section 506, packet transmitting section 505, and packet receiving section 504 in FIG. 5 is modified. The configuration of the second embodiment of the present invention is shown in FIG. 19.

An analyzing section 1906 commands a packet transmitting section 1905 to transmit a network route tracing packet to improve accuracy in estimation of an IP address, in addition to the processing of the analyzing section 506 in FIG. 5. The analyzing section 1906 also conducts IP address isolation processing with reference to a result of network route tracing passed by the packet receiving section 1904.

On receipt of the command to transmit a route tracing packet from the analyzing section 1906, the packet transmitting section 1905 transmits a route tracing packet, in addition to the processing of the packet transmitting section 505 in FIG. 5. The route tracing method performed here comprises checking routers present on a path from one PC to another PC.

On receipt of a result of route tracing from the network, the packet receiving section 1904 passes the result to the analyzing section 1906, in addition to the processing of the packet receiving section 504 in FIG. 5.

Since other configurations are similar to those of the first embodiment shown in FIG. 5, description thereof will be omitted.

### <Operation>

Next, the operation of the second embodiment for practicing the present invention will be described in detail with reference to FIG. 19.

First, processing similar to that in the first embodiment of the present invention is executed to estimate an IP address and a port number of a NAT router. However, at that time, as described above, the IP address and port number have not been isolated to a unique value yet, and there are 32768 combinations.

Next, the analyzing section 1906 performs a network route tracing test. In the route tracing test, workings of TTL (Time To Live) of an IP packet are used to find routers present on a path. TTL is a “lifetime” that can be defined in the IP packet header. Actually, it does not refer to a time but the “number of hops.” That is, TTL defines the number of hops during which a packet can “live out.”

A maximum value that can be defined as TTL is 255, and TTL is always decremented by one for each hop onto a router. Then, once TTL has reached zero, the packet is discarded at that router, and the router that discards the packet sends an ICMP Time Exceeded error in return to a sender PC. The ICMP Time Exceeded error contains an IP address of the router that has discarded the packet. When the sender PC receives the ICMP Time Exceeded error, an IP address of the router that discarded the packet can be detected from the IP source address.

In the aforementioned network route tracing test, repeated trials are made while incrementing TTL from one to acquire information about routers present on a path. For example, if the PC 401 first sends out an IP packet having TTL of one to the PC 405, a first NAT router 402 (a first hop) decrements, on receipt of the packet, TTL to get TTL of zero, and the NAT router 402 then sends an ICMP Time Exceeded error in return. This is the result of the first router. It should be noted that the IP address obtained here is an IP address (192.168.0.1) inside the NAT router 402 (adjacent to the LAN). Next, if the packet is sent out with TTL of two, an IP address of the second router 403 (200.10.1.2) is obtained.

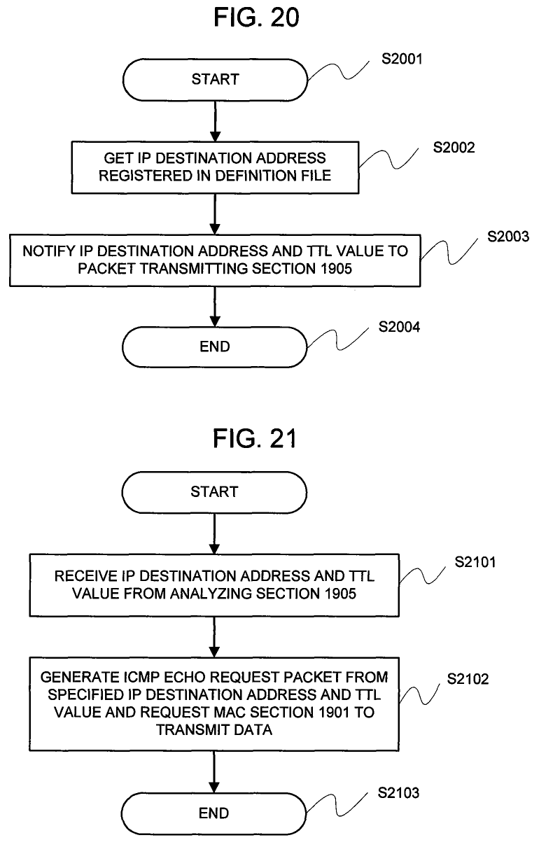

To execute the aforementioned processing, the analyzing section 1906 first acquires an IP destination address registered in a definition file (Step S2001 in FIG. 20), and notifies the IP address of the PC 405 and TTL value of one to the packet transmitting section 1905 (Step S2003 in FIG. 20).

The packet transmitting section 1905 receives the IP destination address from the analyzing section 1906 (Step S2101 in FIG. 21), generates an ICMP Echo Request packet from the received IP destination address and TTL value, and passes it to the MAC section 1901 (Step S2102 in FIG. 21).

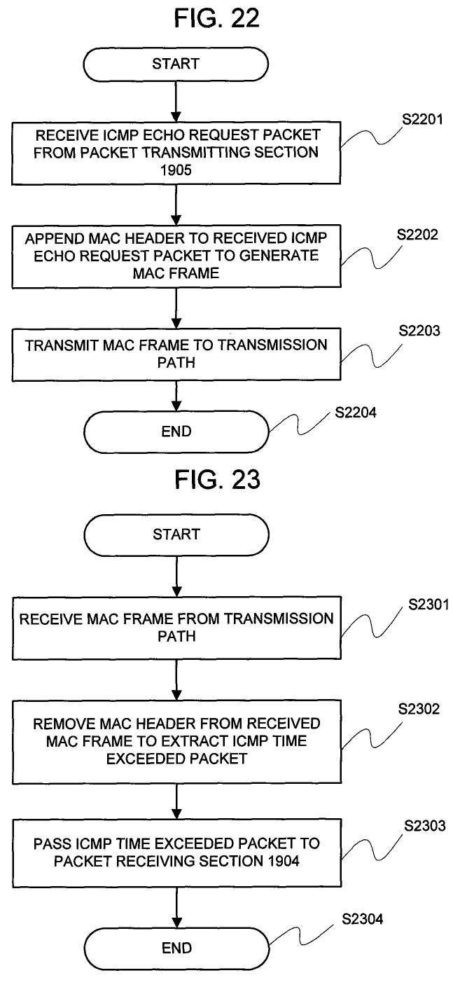

On receipt of the ICMP Echo Request packet from the packet transmitting section 1905 (Step S2201 in FIG. 22), the MAC section 1901 appends a MAC header thereto (Step S2202 in FIG. 22), and transfers it to the network (Step S2203 in FIG. 22).

The packet sent out to the network has TTL decremented by one at every router, and once TTL has reached zero, an ICMP Time Exceeded packet is sent in return to the PC 401 from the current router.

On receipt of the ICMP Time Exceeded packet from the network (Step S2301 in FIG. 23), the MAC section 1901 removes the MAC header therefrom (Step S2302 in FIG. 23), and transfers it to the packet receiving section 1904 (Step S2303 in FIG. 23).

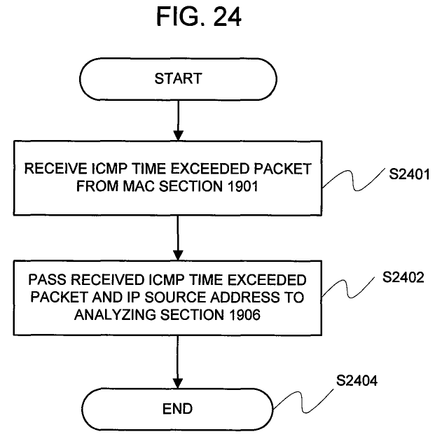

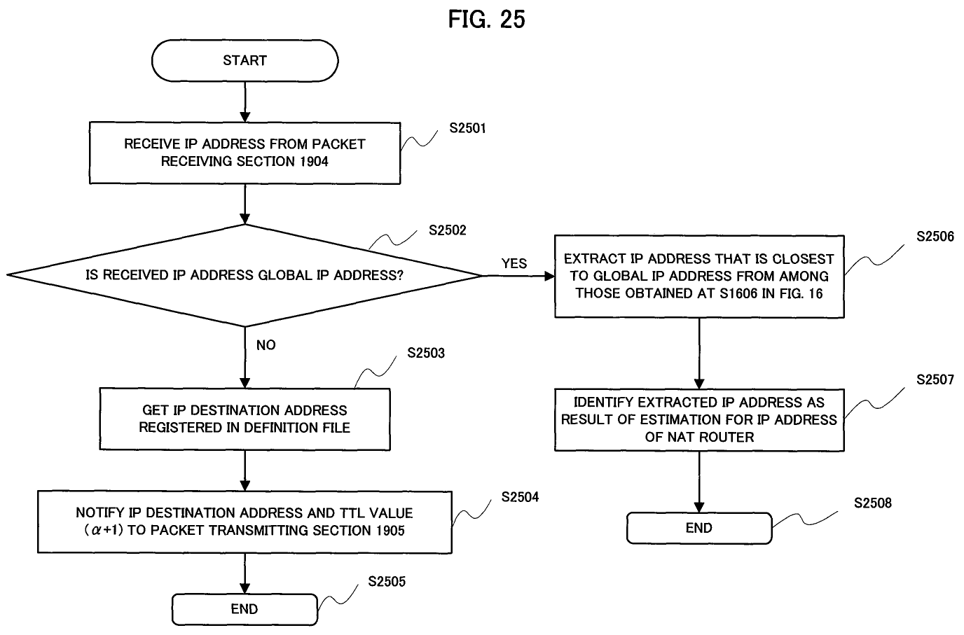

On receipt of the ICMP Time Exceeded packet from the MAC section 1901 (Step S2401 in FIG. 24), the packet receiving section 1904 notifies the IP source address G of the packet to the analyzing section 1906 (Step S2402 in FIG. 24).

On receipt of the IP address G from the packet receiving section 1904 (Step S2501 in FIG. 25), the analyzing section 1906 checks whether the IP address G is a global IP address (Step S2502 in FIG. 25). If the IP address G is not a global IP address, an attempt is made to acquire an IP address of a router at a next hop. Particularly, such processing involves notifying the IP address of the PC 405 and TTL value of two to the packet transmitting section 1905 (Step S2504 in FIG. 25).

On the other hand, if the received IP address G is a global IP address at the aforementioned Step S2502 in FIG. 25, the TTL value at that time (designated as X herein) and the IP address G are stored.

Then, the analyzing section 1906 first tries to isolate an IP address from those estimated in the first embodiment, based on the IP address G.

The method of isolation involves extracting an IP address that is close to the IP address G from those obtained at Step S1606 in FIG. 16, and estimating the extracted IP address as an IP address of the NAT router (Step S2507 in FIG. 25).

Validity of this method of isolation is demonstrated as follows:

The analyzing section 1906 can detect an IP address G (200.10.1.2) of the router 403 according to the aforementioned processing of acquiring network routing information. Since the router 403 belongs to the same sub-network as that of the NAT router 402, the network addresses determined as a subnet mask are the same for the router 403 and NAT router 402. In a case shown in FIG. 4, for example, the IP address of the router 403 and that of the NAT router 402 are the same in an extent up to 200.10.1.

By using such a property, the analyzing section 1906 searches an IP address that is close to the IP address G (200.10.1.2) of the router 403 from those estimated in the first embodiment of the present invention, whereby an IP address that is likely to be the IP address of the NAT router 402 can be selected.

However, although the IP address G (200.10.1.2) of the router 403 can be detected, the number of bits of the subnet mask cannot be detected. Thus, it is necessary to assume the number of bits in the subnet mask, but some assumed values for the subnet mask may result in a plurality of IP addresses that are decided to be close to the IP address G (200.10.1.2) of the router 403 among those estimated in the first embodiment of the present invention.

For example, when the subnet mask is assumed to have 8 bits, about 256 IP addresses of those estimated in the first embodiment of the present invention are probably decided to be close to the IP address G (200.10.1.2) of the router 403.

Alternatively, when the subnet mask is assumed to have 16 bits, only one IP address of those estimated in the first embodiment of the present invention is decided to be close to the IP address G (200.10.1.2) of the router 403.

Thus, success of isolation of a unique IP address depends upon an assumed value for the subnet mask.

The following description will be made on a scheme of further isolation when the subnet mask is assumed to have 8 bits.

Here, the subnet mask is assumed to have 8 bit because it is never defined to have a number of bits less than 8 bits, and such assumption allows the present scheme to be applied to all types of networks.

When the subnet mask is assumed to have 8 bits as described above, about 256 IP addresses can be identified from those estimated the first embodiment of the present invention.

To isolate a unique IP address by refinement of the identified IP addresses, the analyzing section 1906 performs processing as follows:

The analyzing section 1906 first checks, for each of the 256 IP addresses identified as described above, a number of hops required to reach a terminal having that IP address.

The number of hops to a terminal can be checked by using a command such as traceroute (tracert) that is normally supported by an OS like Linux or Windows (registered trademark).

Next, the number of hops up to a position of changeover between a private IP address and a global IP address is checked.

A method of checking the number of hops up to such a router may involve checking routers between the PC's 401 and 405 using the traceroute (tracert) command directed to a terminal having a global IP address, such as the PC 405.

For example, if the traceroute (tracert) command is used from the PC 401 to the PC 405, the following results is returned:

| Number of Hops | Terminal |
|---|---|
| 1 | NAT router 402 (192.168.0.1) |
| 2 | Router 403 (200.10.1.2) |
| 3 | Router 408 |
| 4 | Router 411 |
| 5 | Router 410 |
| 6 | PC 405 (200.20.1.1) |

In this case, the IP address of a terminal changes over from a private IP address to a global IP address between hops 1 and 2. Consequently, the number of hops to a router at which a private IP address changes over to a global IP address is decided to be one.

The analyzing section 1906 uses such a number of hops to a router to isolate a unique IP address from the 256 identified IP addresses. Specifically, among the 256 identified IP addresses, one having a number of hops that matches the aforementioned number of hops (one in this case) to a router is found and that IP address is decided to be an external IP address of the NAT router 402.

Now it has been shown that by the aforementioned processing, a unique IP address of a NAT router can be isolated from a result of network route tracing.

Moreover, since a port number corresponding to the IP address can be uniquely determined, a unique port number can also be isolated.

### <Effect>

Next, effects of the second embodiment for practicing the present invention will be described.

According to the second embodiment for practicing the present invention, details of header conversion can be detected with high accuracy without introducing a special-purpose sever on the Internet, by estimating header conversion with reference to the checksum values in an ICMP header and a result of network route tracing, and thus, the object of the present invention is attained.

Next, a third embodiment for practicing the present invention will be described in detail with reference to the accompanying drawings.

### <Configuration>

According to the first and second embodiments of the present invention, the IP address and port number of a NAT router are estimated based on checksums in an ICMP port-unreachable message sent in return by the PC 405. However, since the ICMP port-unreachable message is a special packet, some NAT routers may discard it.

When an ICMP port-unreachable message is thus discarded at a NAT router, occurrence of header conversion cannot be detected by the first and second embodiments.

From the above, according to the first and second embodiment of the present invention, some types of NAT routers do not allow estimation of details of header conversion, resulting in poor usability.

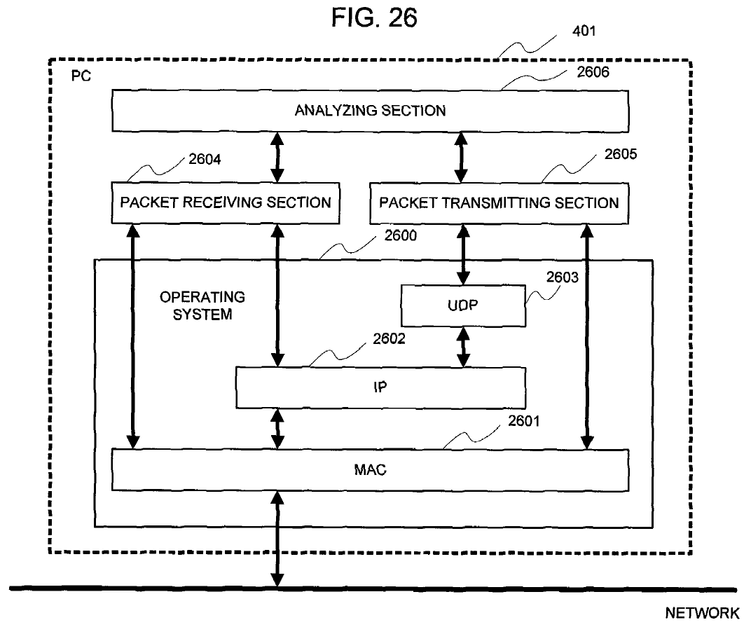

According to the third embodiment of the present invention, processing executed by the analyzing section 506, packet transmitting section 505, and packet receiving section 504 in FIG. 5 is modified to solve the aforementioned problem. The configuration of the third embodiment of the present invention is shown in FIG. 26.

The analyzing section takes advantage of an ICMP Time Exceeded error that is a more common message, in place of an ICMP port-unreachable message, to diversify the types of NAT routers that can detect header conversion of a network, in addition to the processing of the analyzing section 506 in FIG. 5. To cause a router to send the ICMP Time Exceeded error in return, an analyzing section 2606 commands a packet transmitting section 2605 to transmit a UDP packet whose TTL is set to a small value. The analyzing section 2606 also estimates details of header conversion applied in the network with reference to header information of an ICMP Time Exceeded message passed by a packet receiving section 2604.

On receipt of the command to transmit a UDP packet from the analyzing section 2606, the packet transmitting section 2605 passes data to a MAC section 2601 for performing processing of transmitting a UDP packet to a specified destination.

The packet receiving section 2604 receives the ICMP Time Exceeded message sent by a router, and passes its header information to the analyzing section 2606.

Since other configurations are similar to those of the second embodiment shown in FIG. 19, description thereof will be omitted.

### <Operation>

Next, the operation of the third embodiment for practicing the present invention will be described in detail with reference to FIG. 26.

First, the analyzing section 2606 transmits a UDP packet or a TCP packet triggered by certain timing.

The time at which a UDP packet or a TCP packet is transmitted may be one or a combination of the following:

@ when commanded by a user interface or other applications;

@ when activating a service of the analyzing section;

@ when turning the power of a PC on;

@ at certain time intervals; and

@ when updating an IP address of a PC.

It should be understood that these times of transmission are merely listed by way of example. It would be obvious to those skilled in the art by reviewing the present description that a wide variety of kinds of times of transmission may be contemplated.

A destination of a UDP packet or a TCP packet may be one or a combination of the following:

@ transmission is made toward an IP address and a port number specified by a user interface or other applications;

@ transmission is made toward an IP address and a port number predefined in a definition file or the like; and

@ transmission is made toward a randomly selected IP address and port number.

It should be understood that these destinations of a packet are merely listed by way of example. It would be obvious to those skilled in the art by reviewing the present description that a wide variety of destinations of a packet may be contemplated.

The following description of the operation will be made on a case in which a method is adopted to transmit a UDP packet toward an IP address and a port number pre-registered in a definition file upon activation of a service of the analyzing section.

In the definition file here, it is assumed that an IP address of 200.20.1.1 and a port number of 9999 have been registered for the PC 405.

Although the port number is assumed to be 9999, it would be obvious to those skilled in the art that any port number may be selected because it is unnecessary to send an ICMP port-unreachable message in return in the third embodiment, unlike the first embodiment.

Moreover, a UDP packet transmitted here has TTL set to have a very small value such as two or three.

A small value is set here to TTL because an ICMP TTL Exceeded message can be sent in return by a router in the network.

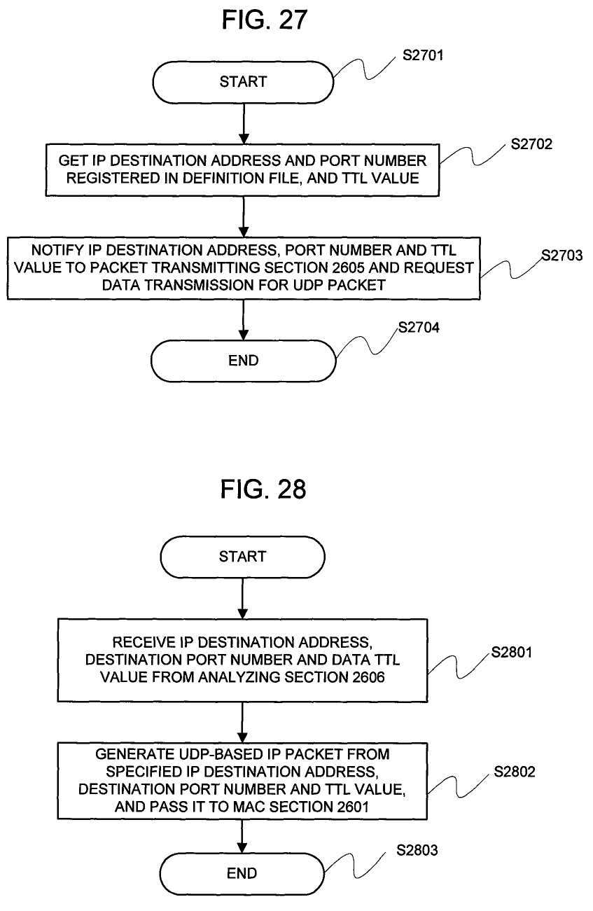

The analyzing section 2606 notifies the aforementioned IP address, port number and TTL value to the packet transmitting section 2605, and requests transmission of a UDP packet (Step S2703 in FIG. 27).

The packet transmitting section 2605 generates a UDP-based IP packet from the IP destination address, port number and TTL value received from the analyzing section 2606, and passes it to the MAC section 2601 (Step S2802 in FIG. 28)

On receipt of the IP packet from the packet transmitting section 2605, the MAC section 2601 appends a MAC header thereto to generate a MAC frame, and transmits it to the transmission path (1101 in FIG. 11).

The thus-transmitted data first undergoes modification of its IP source address and source port number at the NAT router 402 of FIG. 4. In this example, the IP source address is modified from 192.168.0.2 to 200.10.1.1, and the source port number is modified from 65000 to 65001. Moreover, the modification also entails recalculation of checksums of the IP header and of the UDP header. In this example, a checksum of the IP header is modified from 0x10 to 0x20, and a checksum of the UDP header is modified from 0x100 to 0x200. Furthermore, TTL is rewritten from two to one at the NAT router (1102 in FIG. 11).

The thus-modified packet is next delivered to the router 403. At the router 403, TTL is rewritten again from one to zero, and TTL now becomes zero upon which this packet is discarded. Then, the router 403 sends an ICMP Time Exceeded message in return to the NAT router 402 that is a sender of the packet.

The ICMP Time Exceeded message is sent as a packet as shown in 1103 in FIG. 11, whose data portion is attached with the packet received earlier by the router 403 without modification.

On receipt of the ICMP Time Exceeded message, the NAT router 402 modifies the IP destination address in the IP header from 200.10.1.1 to 192.168.0.2 for transferring it to the PC 401. The modification also entails recalculation of a checksum of the IP header and it is modified from 0x30 to 0x40.

The NAT router 402 also modifies the data portion of the ICMP Time Exceeded message. Specifically, it modifies the IP source address from 200.10.1.1 to 192.168.0.2, and the source port number from 65001 to 65000. By thus modifying the data portion of the ICMP header as well, the ICMP Time Exceeded message can be made to still look like an ICMP Time Exceeded message to the PC 401.

The NAT router 402, however, does not modify the checksum of the data portion of the ICMP header, and hence, the checksum has a false value (1104 in FIG. 11).

On receipt of the ICMP packet from the NAT router 402, the PC 402 first removes the MAC header therefrom at the MAC section 2601, and then transfers it to the IP section 2602.

On receipt of the ICMP packet from the MAC section 2601, the IP section 2602 removes the IP header therefrom, and then decides whether the data represents a data portion of an ICMP packet transmitted in response to a UDP packet. If it is decided to represent an ICMP packet transmitted in response to a UDP packet as a result of the decision, it is transferred to the packet receiving section 2604.

On receipt of the ICMP packet from the IP section 2602, the packet receiving section 2604 transfers the data portion of the ICMP header to the analyzing section 2606.

On receipt of the data portion from the packet receiving section, the analyzing section 2606 detects whether header conversion has been made in the network with reference to the status of its checksums.

Specifically, when IP address translation has been made, it can be detected because the IP checksum of the data portion has a false value. When port number translation has been made, it can be also detected because a UDP checksum of the data portion has a false value.

Once header conversion has been detected, the analyzing section 2606 starts processing of estimating details of modification in the header. Since the estimation processing executed by the analyzing section is similar to that executed by the analyzing section 506 in the first embodiment, description thereof will be omitted.

While the third embodiment of the present invention solely cannot identify a unique IP address and port number for the same reason as in the first embodiment of the present invention, accuracy in estimation can be improved by combining the third embodiment with the second embodiment of the present invention.

Now it has been shown that by the aforementioned processing, even if an ICMP port-unreachable message is discarded at a NAT router, an IP source address and port number of a NAT can be estimated by using an ICMP Time Exceeded error that is more common message.

### <Effect>

Next, effects of the third embodiment for practicing the present invention will be described.

According to the third embodiment for practicing the present invention, even if an ICMP port-unreachable message is discarded in a network, header conversion applied in the network can be detected without introducing a special-purpose sever on the Internet, by estimating header conversion in the network based on information of an ICMP Time Exceeded message sent in return by a router, and thus, the object of the present invention is attained.

Next, a fourth embodiment for practicing the present invention will be described in detail with reference to the accompanying drawings.

### <Configuration>

According to the first, second, and third embodiments of the present invention, it is assumed that not only an IP address but also a port number are translated at the NAT router 402, as shown in 1102 in FIG. 11. That is, it is assumed that NAPT processing is executed at the NAT router 402. Moreover, it is assumed that, at the NAT router 402, an IP checksum and a UDP checksum among checksums in an ICMP packet sent in return by the network are both transferred as having their false values, as shown in 1104 in FIG. 11.

However, some NAT routers may simply operate header conversion in a different manner from that shown in 1102 in FIG. 11, such that they often convert only an IP address and not a port number. Moreover, some NAT routers operate header conversion in a different manner from that shown in 1104 in FIG. 11, such that they often modify an IP checksum, among checksums in an ICMP packet sent in return by a network, into a correct value, and then transfer the packet.

According to the fourth embodiment of the present invention, the operation of the NAT router 402 is assumed to include NAT processing as described above, and in addition, correction on an IP checksum into a correct value; and now a method of estimating an IP address of a NAT router from checksum values in an ICMP packet even in such a condition will be described hereinbelow.

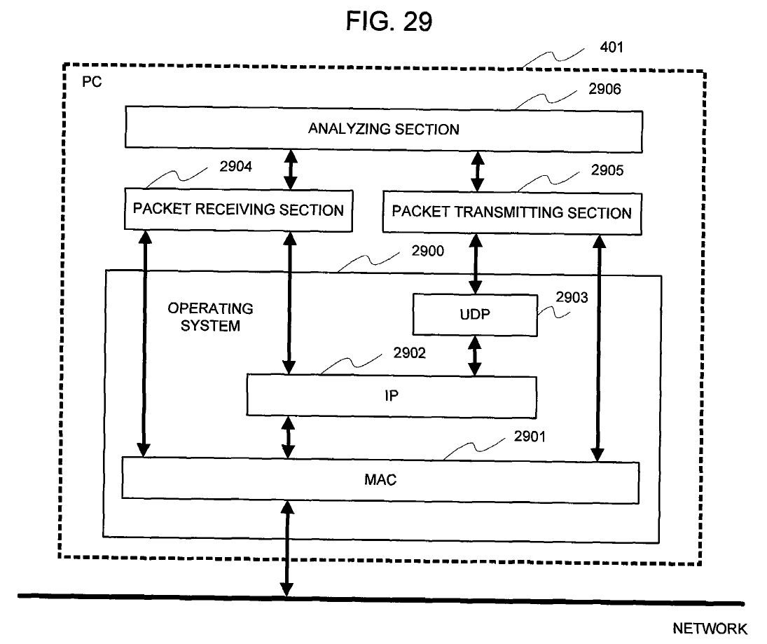

According to the fourth embodiment of the present invention, the processing executed by the analyzing section 2606, packet transmitting section 2605, and packet receiving section 2604 in FIG. 26 is modified to solve the aforementioned problem. The configuration of the fourth embodiment of the present invention is shown in FIG. 29.

An analyzing section 2906 commands a packet transmitting section 2905 to transmit a packet to a certain destination to ascertain whether the NAT router 402 performs a NAT operation, in addition to the processing of the analyzing section in FIG. 26. Moreover, the analyzing section 2906 detects details of header conversion applied in the network with reference to header information of an ICMP Time Exceeded message passed by the packet receiving section 2904.

On receipt of the command of packet transmission from the analyzing section 2906, the packet transmitting section 2905 passes data to a MAC section 2601 for performing processing of transmitting a packet to a specified destination.

The packet receiving section 2904 receives an ICMP Time Exceeded message sent in return by a router, and passes its header information to the analyzing section 2906.

### <Operation>

Next, the operation of the fourth embodiment for practicing the present invention will be described in detail with reference to FIG. 29.

Since the processing of transmitting a packet from the analyzing section 2906 to the PC 405 is similar to that in the third embodiment, description thereof will be omitted.

In the following description of the operation, it is assumed that a UDP packet is transmitted from the PC 401 as in the third embodiment; however, it would be obvious to those skilled in the art that a TCP packet may be transmitted in place of a UDP packet without any problem.

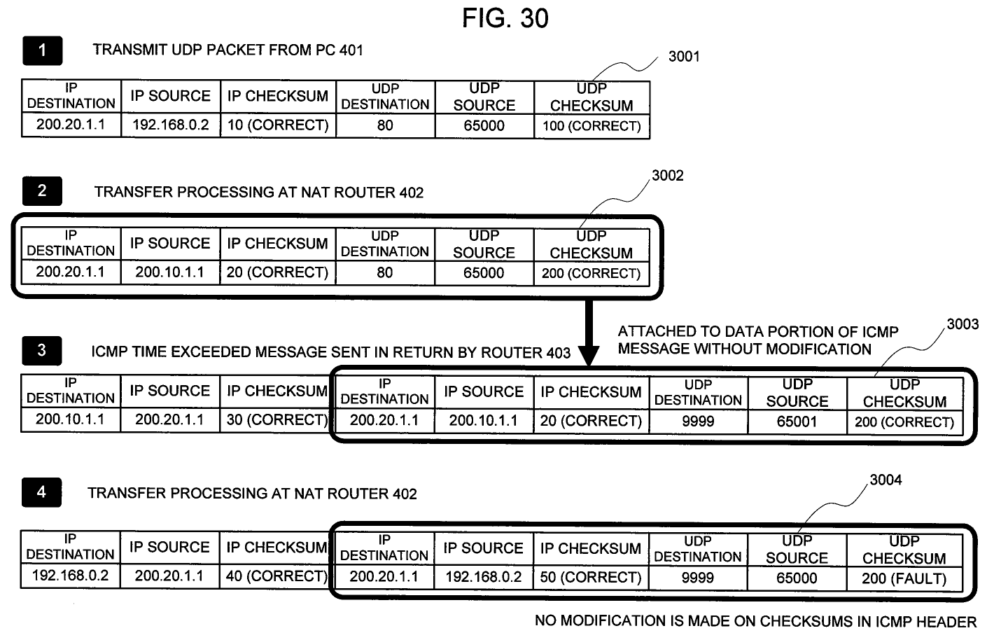

The thus-transmitted data first undergoes modification of its IP source address at the NAT router 402 of FIG. 4. In this example, the IP source address is modified from 192.168.0.2 to 200.10.1.1, as shown in 3002 in FIG. 30. The source port number, however, is unmodified from its original number 65000. The modification also entails recalculation of checksums of the IP header and of the UDP header.

In this example, a checksum of the IP header is modified from 0x10 to 0x20, and a checksum of the UDP header is modified from 0x100 to 0x200. Moreover, TTL is rewritten from two to one at the NAT router 402.

The thus-modified packet is next delivered to the router 403. At the router 403, TTL is rewritten again from one to zero, and TTL now becomes zero upon which this packet is discarded. Then, the router 403 sends an ICMP Time Exceeded message in return to the NAT router 402 that is a sender of the packet.

The ICMP Time Exceeded message is sent as a packet as shown in 3003 in FIG. 30, whose data portion is attached with the packet received earlier by the router 403 without modification.

On receipt of the ICMP Time Exceeded message, the NAT router 402 modifies the IP destination address in the IP header from 200.10.1.1 to 192.168.0.2 for transferring it to the PC 401. The modification also entails recalculation of a checksum of the IP header and it is modified from 0x30 to 0x40.

The NAT router 402 also modifies the data portion of the ICMP Time Exceeded message. Specifically, it modifies the IP source address from 200.20.1.1 to 192.168.0.2. By thus modifying the data portion of the ICMP header as well, the ICMP Time Exceeded message can be made to still look like an ICMP Time Exceeded message to the PC 401. The modification also entails recalculation of an IP checksum among the checksums in an ICMP header and it is modified from 0x20 to 0x50, as shown in 3004 in FIG. 30.

The NAT router 402, however, does not modify the UDP checksum, and hence, the UDP checksum has a false value.

On receipt of the ICMP packet from the NAT router 402, the PC 401 transfers the data portion of the ICMP header to the analyzing section 2906, according to the processing described in the third embodiment.

On receipt of the data portion of the ICMP header from the packet receiving section 2904, the analyzing section 2906 detects whether header conversion has been made in the network with reference to the status of its checksums.

Then, since the IP checksum of the data portion has a correct value, it is impossible to detect whether IP address translation is made at the NAT router 402 from the IP checksum.

On the other hand, the UDP checksum has a false value, and therefore, IP address translation or port number translation at the NAT router 402 can be detected.

The false UDP checksum is then ascribed to IP address translation because the UDP checksum is calculated incorporating a pseudo-header including an IP address as shown in FIG. 18.

Hence, the analyzing section 2906 assumes that IP address translation has been made at the NAT router 402, and estimates an IP address of the NAT router 402 with reference to the UDP checksum. Since the estimation processing is similar to that in the first embodiment of the present invention, description thereof will be omitted. Moreover, since the estimation processing solely cannot identify a unique IP address of the NAT router 402, it is desirable to additionally conduct a network route tracing test to improve accuracy in estimation as in the second embodiment.

Now it has been shown that by the aforementioned processing, even if an IP checksum is modified into a correct value at the NAT router 402, an IP address of the NAT router 402 can be estimated with reference to the value of a UDP checksum.

### <Effect>

Next, effects of the fourth embodiment for practicing the present invention will be described.

According to the fourth embodiment for practicing the present invention, even if an IP checksum is modified into a correct value at a NAT router, an IP address of the NAT router can be estimated with reference to the value of a UDP checksum in an ICMP packet, and thus, the object of the present invention that header conversion is detected without introducing a special-purpose sever on the Internet is attained.

Next, a fifth embodiment for practicing the present invention will be described in detail with reference to the accompanying drawings.

### <Configuration>

According to the first-fourth embodiments of the present invention, a method of estimating an IP address and port number of a NAT router is described. A fifth embodiment of the present invention will address a method of estimating information required in transmitting/receiving a packet between PC's connected downstream of NAT routers, in addition to estimating information about the NAT router as described above.

Specifically, a method of estimating information required to communicate a packet between the PC's 401 and 407 of FIG. 4 will be described here.

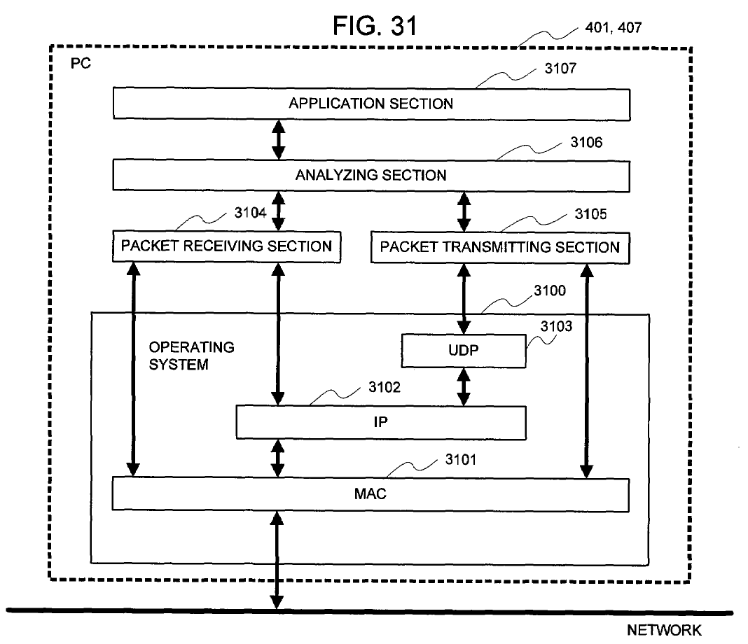

The configuration of the fifth embodiment of the present invention is shown in FIG. 31. According to the fifth embodiment of the present invention, the processing executed by the analyzing section 2606, packet transmitting section 2605, and packet receiving section 2604 in FIG. 26 is modified, and an application section 3107 is included to solve the aforementioned problem.

An analyzing section 3106 in FIG. 31 notifies an IP address and a port number of a NAT router to which its own node is connected, to a PC that serves as a communication partner, in addition to the processing of the analyzing section 2606 in FIG. 26. The analyzing section 3106 also receives from a PC that serves as a communication partner an IP address and a port number of a NAT router to which the PC is connected, and commands a packet transmitting section 3105 to transmit a UDP packet to the IP address and port number.

When the application section 3107 attempts to transmit data to a PC that serves as a communication partner, it issues a data transmission request to the analyzing section 3106. When the application section 3107 is to receive data from a PC that serves as a communication partner, it receives the data from the analyzing section 3106.

Since other configurations are the same as those in the first-fourth embodiments, description thereof will be omitted.

### <Operation>

Next, the operation of the fifth embodiment for practicing the present invention will be described in detail with reference to FIG. 31.

First, the analyzing section 3106 transmits a UDP packet or TCP packet triggered by certain timing.

The time at which UDP packet or TCP packet is transmitted may be one or a combination of the following:

@ when commanded by a user interface or other applications;

@ when activating a service of the analyzing section;

@ when turning the power of a PC on;

@ at certain time intervals; and

@ when updating an IP address of a PC.

It should be understood that these times of transmission are merely listed by way of example. It would be obvious to those skilled in the art by reviewing the present description that a wide variety of kinds of times of transmission may be contemplated.

A destination of a UDP packet or a TCP packet may be one or a combination of the following:

@ transmission is made toward an IP address and a port number specified by a user interface or other applications;

@ transmission is made toward an IP address and a port number predefined in a definition file or the like; and

@ transmission is made toward a randomly selected IP address and port number.

It should be understood that these destinations of a packet are merely listed by way of example. It would be obvious to those skilled in the art by reviewing the present description that a wide variety of destinations of a packet may be contemplated.

The following description of the operation will be made on a case in which a method is adopted to transmit a UDP packet toward an IP address and a port number pre-registered in a definition file upon a command from the application section 3107.

In the following description of the operation, it is assumed that a UDP packet is transmitted from the PC 401 as in the third embodiment; however, it would be obvious to those skilled in the art that a TCP packet may be transmitted in place of a UDP packet without any problem.

Since the processing of transmitting a UDP-based IP packet from the analyzing section 3106 is similar to that in the third embodiment, description thereof will be omitted.

Moreover, since the header conversion processing at the NAT router 402 and processing of returning an ICMP Time Exceeded packet at the router 403 are similar to those in the third embodiment, description thereof will be omitted.

The PC 401 receives an ICMP Time Exceeded packet sent in return by the router 403.

Since the processing of passing the data portion of the header in the ICMP Time Exceeded packet to the analyzing section 3106 is similar to that in the third embodiment, description thereof will be omitted.

On receipt of the data portion of the header of the ICMP Time Exceeded packet from the packet receiving section 3104, the analyzing section 3106 detects whether header conversion has been made in the network with reference to the status of its checksums.

If the analyzing section 3106 detects header conversion, it starts processing of estimating details of modification on the header; since the estimation processing performed here is similar to that performed at the analyzing section in the third embodiment, description thereof will be omitted.

The analyzing section 3106 notifies the thus-estimated IP address and port number of the NAT router 402 to the PC 407 that serves as a communication partner.

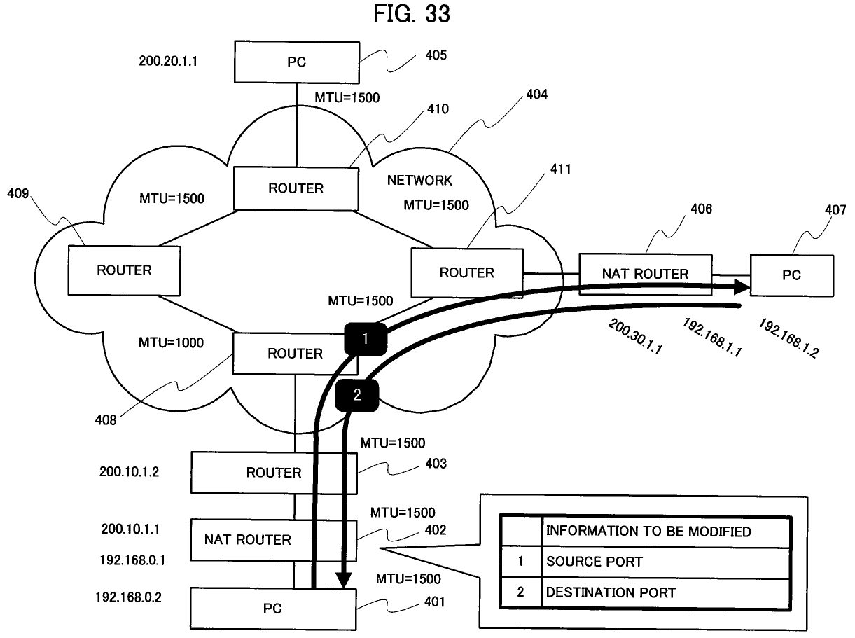

It may be contemplated that the means of notifying includes notification by sending a mail to a user at the PC 407 that serves as a communication partner, calling the user, sending a FAX to the user, or the like. Such notification is shown as a path 1 in FIG. 33.

Next, the operation of the PC 407 that serves as a communication partner will be described.

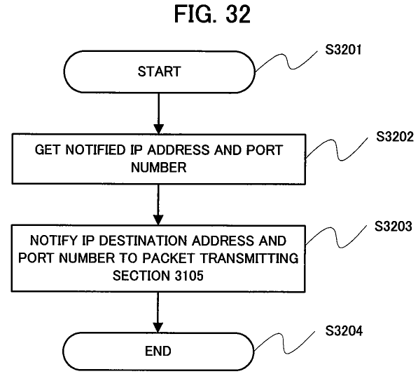

On receipt of the IP address and port number of the NAT router 402 from the PC 401 by the notifying means, the analyzing section 3106 of the PC 407 notifies the IP address and port number to the packet transmitting section 3105, and requests transmission of a UDP packet (Step S3203 in FIG. 32).

Since the processing of transmitting a packet thereafter is similar to that in the first embodiment shown in FIGS. 7-10, description thereof will be omitted.

The data thus transmitted from the PC 407 undergoes modification of its IP source address and source port number at the NAT router 406 in FIG. 4. In this example, the IP source address is modified from 192.168.1.2 to 200.30.1.1, and the source port number is modified from 65000 to 65001.

The thus-modified packet is delivered to the NAT router 402 on the communication partner.

If the operation mode of the NAT router 402 is of a type generally called “Full Cone NAT” as disclosed in Non-patent Document 1, the thus-delivered packet is transferred from the NAT router 402 to the PC 401 instead of being discarded at the NAT router 402.

On receipt of the packet from the NAT router 402, the PC 401 takes the packet up to the packet receiving section 3104 via the MAC section 3101.

On receipt of the packet from the packet receiving section 3104, the analyzing section 3106 can get the IP address and port number of the NAT router 406 on the communication partner with reference to the header of the packet.

Thus, information required to communicate a packet between the PC's 401 and 407 connected to NAT routers can be estimated by the aforementioned processing.

Thereafter, when communication is to be established between applications in the PC's 401 and 407, the application section 3107 communicates data via the analyzing section 3106. For example, on receipt of data from the application section 3107, the analyzing section 3106 notifies the IP address and port number of a NAT router attached to the communication partner to the packet transmitting section 3105, and requests transmission of a UDP packet. Since the transmission processing thereafter is similar to that in the first embodiment shown in FIGS. 7-10, description thereof will be omitted.

On the other hand, the PC 407 takes the packet transmitted from the PC 401 up to the analyzing section 3106 via the MAC section 3101, according to the processing of the first embodiment shown in FIGS. 12-14. Thereafter, the data is transferred from the analyzing section 3106 to the application section 3107.

The foregoing description has addressed the operation of the NAT router in an operation mode of a type generally called “Full Cone NAT.”

On the other hand, if the operation mode of the NAT router is of a type generally called “Restricted Cone NAT” or “Port Restricted Cone NAT” as disclosed in Non-patent Document 1, a packet transmitted from the PC 407 to the NAT router 402 is discarded at the NAT router 402 at Step S3203 in FIG. 32.

The packet is thus discarded because such a NAT router accepts only packets transmitted by an IP address/port number that has once transmitted a packet, as disclosed in Non-patent Document 1.

According to the fifth embodiment of the present invention, the following processing is performed to estimate information required to communicate packets even if a NAT router is of such a type.

On receipt of the IP address and port number of the NAT router 402 from the PC 401 by the aforementioned notifying means, the PC 407 first attempts to get the IP address and port number of the NAT router 406. A method of getting information on the NAT router 406 involves transmitting a UDP packet having a smaller TTL value, as in the third embodiment. However, a destination for the UDP packet transmitted here is specified as the IP address and port number of the NAT router 402 notified by the PC 401.

Since the processing of transmitting a packet performed here is similar to that in the third embodiment shown in FIGS. 27 and 28, description thereof will be omitted.

The packet thus transmitted from the PC 407 first undergoes modification of its IP source address and source port number at the NAT router 407 of FIG. 4. Since details of the modification are similar to those shown in FIG. 11, description thereof will be omitted.

The thus-modified packet is next delivered to the router 411. At the router 411, TTL is rewritten from one to zero, and TTL now becomes zero upon which this packet is discarded. Then, the router 411 sends an ICMP Time Exceeded message in return to the NAT router 406 that is a sender of the packet.

On receipt of the ICMP Time Exceeded message from the NAT router 406, the PC 407 can get the IP address and port number of the NAT router 406 with reference to its checksums, as in the third embodiment.

Since the processing of receiving a packet and processing of estimating details of modification on a header performed here are similar to those in the third embodiment, description thereof will be omitted.

The analyzing section 3106 in the PC 407 notifies the thus-estimated IP address and port number of the NAT router 406 to the PC 401 that serves as a communication partner.

It may be contemplated that the notifying means includes notification by sending a mail to a user at the PC 401 that serves as a communication partner, calling the user, sending a FAX to the user, or the like. Such notification is shown as a path 2 in FIG. 33.

On receipt of the IP address and port number of the NAT router 406 from the PC 407 by the notifying means, the analyzing section 3106 in the PC 401 notifies the IP address and port number to the packet transmitting section 3105, and requests transmission of a UDP packet (Step S3203 in FIG. 32).

Since the processing of transmitting a packet performed here is similar to that in the first embodiment shown in FIG. 7-FIG. 10, description thereof will be omitted.

The data thus transmitted undergoes modification of its IP source address and source port number at the NAT router 402 in FIG. 4, and then, delivered to the NAT router 406 on the communication partner.

Since the NAT router 406 has transmitted a packet to the NAT router 402 that is a sender of the packet in the previous communication processing, it transfers the packet to the PC 407 instead of discarding it.

On receipt of the packet from the NAT router 402, the PC 407 takes the packet up to the analyzing section 3106 via the MAC section 3101; since the processing is similar to that in the first embodiment shown in FIGS. 12-14, description thereof will be omitted.

On receipt of the packet from the packet receiving section 3104, the analyzing section 3106 can get the IP address and port number of the NAT router 406 on the communication partner with reference to the header of the packet.

Thus, information required to communicate a packet between the PC's 401 and 407 connected to NAT routers can be estimated by the aforementioned processing.

Thereafter, when communication is to be established between applications of the PC's 401 and 407, the application section 3107 communicates data via the analyzing section 3106.

Now it has been shown that even if PC's are connected to NAT routers, information required to communicate packets between the PC's can be estimated by notifying an IP address and a port number of each NAT router estimated from checksums in an ICMP packet to each respective communication partner.

The foregoing description has addressed the operation of a NAT router in an operation mode of a type generally called “Restricted Cone NAT” or “Port Restricted Cone NAT.”

On the other hand, if the operation mode of the NAT router is of a type generally called “Symmetric NAT” as disclosed in Non-patent Document 1, the aforementioned processing cannot prevent a packet transmitted from the PC 401 to the NAT router 406 from being discarded at the NAT router 406.

The packet is thus discarded because in such a NAT router, a source port number at the NAT router is changed depending upon an IP destination address/destination port number, as disclosed in Non-patent Document 1. For example, in the path 1 of FIG. 33, a port number of the NAT router 402 for communication with the PC 405 is notified from the PC 401 to the PC 407, and the PC 407 transmits a packet destined for the received port number. The PC 407 also notifies the PC 401 of a source port number assigned by the NAT router 406 to the packet now being transmitted in the path 2 of FIG. 33. The PC 401 transmits a packet destined for the received port number. It should be noted here that the source port number of the packet transmitted at that time from the PC 401 is given a value different from the port number for communication with the PC 405 due to the property of “Symmetric NAT.” Once the NAT router 406 has received such a packet, it discards the packet because a mapping table for the source port number has not been created yet. From the above, the aforementioned method cannot accommodate “Symmetric NAT.”

According to the fifth embodiment of the present invention, the following processing is performed to estimate information required to communicate packets even if a NAT router is of such “Symmetric NAT.”

On receipt of the IP address and port number of the NAT router 402 from the PC 401 by the aforementioned notifying means, the PC 407 first estimates an IP address of the NAT router 406 and a port number for communication with the NAT router 402.

Since the estimation processing performed here is similar to that for the NAT router that is of “Restricted Cone NAT” or “Port Restricted Cone NAT” and such processing is described earlier, description thereof will be omitted.

It should be noted that a port number that can be estimated here is nevertheless one that is assigned at the NAT router 406 to a port number of the NAT router 402 for communication with the PC 405.

Once the PC 407 has thus got the IP address of the NAT router 406 and the port number for communication with the NAT router 402, it next checks regularity of assignment processing for the port number of the NAT router 406. Non-patent Document 1 discloses regularity in “Symmetric NAT.” According to Non-patent Document 1, a NAT router having the property of “Symmetric NAT” often assigns the source port number with a value that increments by one.

According to the fifth embodiment of the present invention, to check such regularity, a plurality of packets are transmitted from the PC 407 destined for terminals having global IP addresses, and a source port number assigned to each destination at the NAT router 406 is estimated according to the third embodiment. Based on the source port number estimated as described above, the PC 407 knows regularity of “Symmetric NAT,” and estimates a “real” port number defined for communication with the NAT router 402.

The PC 407 notifies the thus-estimated port number and the IP address of the NAT router 406 to the PC 401.

On the other hand, the PC 401 transmits a packet destined for the IP address and port number received from the PC 407, and estimates a source port number assigned to the packet by the NAT router 402. Since the estimation processing is similar to that in the third embodiment, description thereof will be omitted. The PC 401 notifies the thus-estimated port number to the PC 407 again.

Thus, the PC 407 transmits a packet destined for the port number received from the PC 401 (where the IP destination address is also the PC 401). At that time, the NAT router 406 converts the source port number for the packet into one that is estimated from the aforementioned regularity of “Symmetric NAT.” Once the thus-converted packet has reached the NAT router 402, the NAT router 402 transfers the packet to the PC 401 instead of discarding it because a mapping table has been created according to the aforementioned packet transmission processing.

Now it has been shown that even if PC's are connected to NAT routers, information required to communicate packets between the PC's can be estimated by notifying an IP address and a port number of each NAT router estimated from checksums in an ICMP packet to each respective communication partner.

The foregoing description has addressed the operation of a NAT router in an operation mode of a type generally called “Symmetric NAT.”

In the foregoing description, it is presupposed that a unique IP address or port number of a NAT router can be isolated by using the method according to the first-fourth embodiments of the present invention. On the contrary, if the method cannot isolate a unique IP address or port number to leave a plurality of candidates, there is a possibility that a connection request from an incorrect communication partner is accepted.

To avoid such a problem, according to the fifth embodiment, a connection request from a partner other than a desired one can be prevented by appending information that can identify a communication partner, such as a mail address or identifier, into a packet.

### <Effect>

Next, effects of the fifth embodiment for practicing the present invention will be described.

According to the fifth embodiment for practicing the present invention, even if a PC that serves as a communication partner is located downstream of a NAT router, information required to communicate a packet between the PC's can be estimated without introducing a special-purpose sever on the Internet, by estimating an IP address and a port number of the NAT router from checksums in an ICMP packet and notifying the information to each other, and thus, the object of the present invention is attained.

Next, a sixth embodiment for practicing the present invention will be described in detail with reference to the accompanying drawings.

### <Configuration>

While the first-fifth embodiments of the present invention address a method of estimating an IP address and a port number of a NAT router, a method of estimating a change in a ToS field will be described in the sixth embodiment of the present invention.

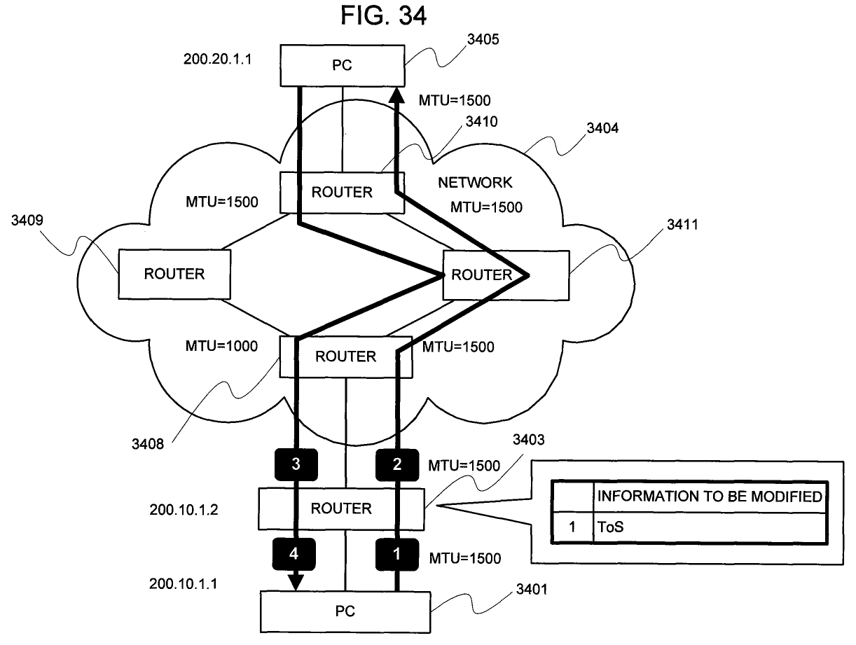

Referring to FIG. 34, the sixth embodiment of the present invention comprises a network 3404 such as the Internet, a PC 3401 operated by a user, any given PC 3405 on the Internet, and a router 3403 for controlling routing of packets. The network 3404 also comprises routers 3408-3411 for controlling routing of packets.

At this time, the router 3403 modifies a ToS field of a packet to preferentially handle a specific flow.

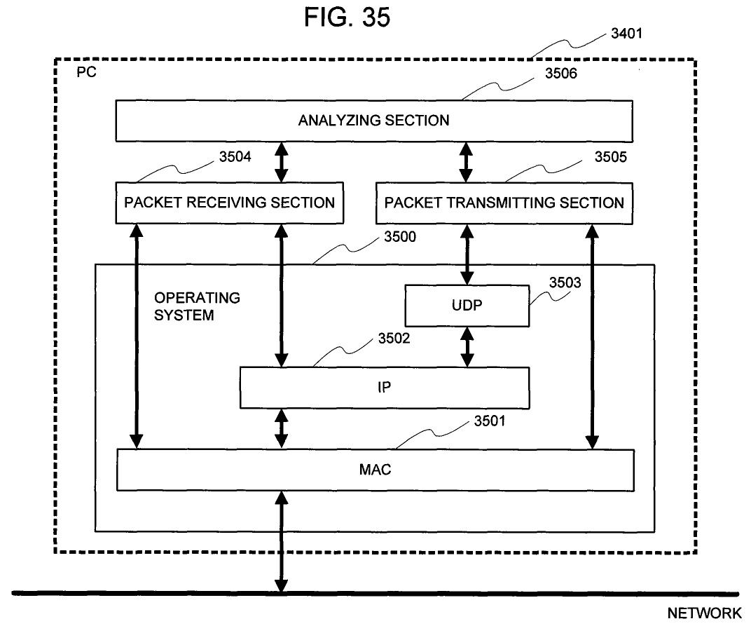

FIG. 35 shows the internal configuration of the PC 3401.

As shown in FIG. 35, the internal configuration of the PC 3401 is similar to that of the PC 401 in FIG. 26. According to the sixth embodiment of the present invention, however, the processing executed by the analyzing section 2606 in FIG. 26 is modified to solve the aforementioned problem.

The analyzing section 3506 according to the sixth embodiment of the present invention, processing of detecting a change in a ToS field made in a network is performed with reference to an ICMP Time Exceeded message passed by the packet receiving section 3504, in addition to the processing of the analyzing section 2606 in FIG. 26.

Since other processing is similar to that in the third embodiment shown in FIG. 26, description thereof will be omitted.

### <Operation>

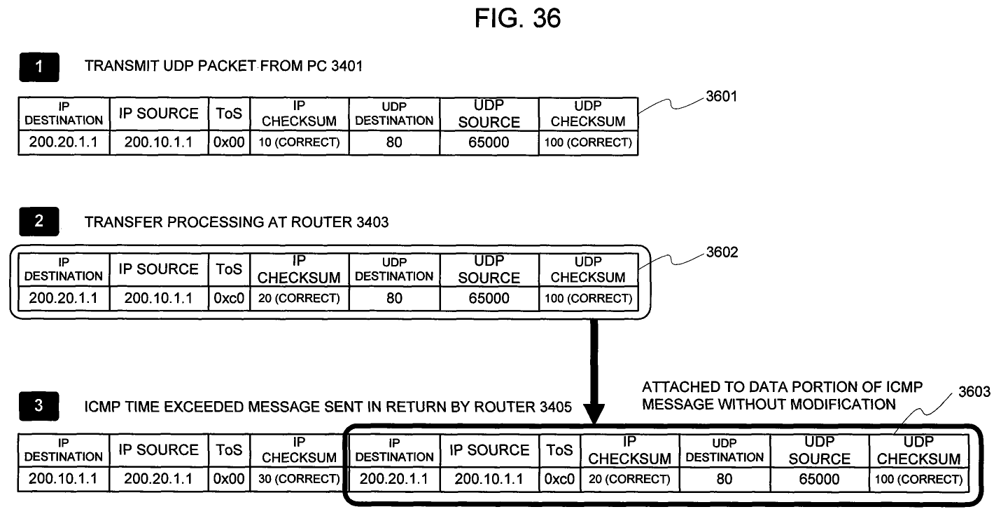

Since the processing of transmitting a packet having a small TTL value from a PC 3401 is similar to that in the third embodiment, description thereof will be omitted (3601 in FIG. 36).

In the following description of the operation, it is assumed that a UDP packet is transmitted from the PC 3401 as in the third embodiment; however, it would be obvious to those skilled in the art that a TCP packet may be transmitted in place of a UDP packet without any problem.

Data transmitted from the PC 3401 first undergoes modification of a ToS field in its IP header at the router 3403 of FIG. 34. In this example, the ToS field is modified from 0x00 to 0xc0. The modification also entails recalculation of a checksum of the IP header. In this example, a checksum of the IP header is modified from 0x10 to 0x20 (3602 in FIG. 36). Moreover, the router 3403 rewrites TTL from two to one.

The thus-modified packet is next delivered to the router 3408. The router 3408 further rewrites TTL from one to zero, and TTL now becomes zero upon which this packet is discarded. Then, the router 3408 sends an ICMP Time Exceeded message in return to the PC 3401 that is a sender of the packet. The ICMP Time Exceeded message is sent as a packet as shown in 3603 in FIG. 36, whose data portion is attached with the packet received earlier by the router 3408 without modification.

On receipt of the ICMP packet from the router 3408, the PC 3401 takes it up to the analyzing section 3506 via the MAC section 3501, as in the third embodiment.

On receipt of the data portion of the header of the ICMP Time Exceeded message from the packet receiving section 3504, the analyzing section 3506 can detect whether the ToS field has been modified in the network with reference to the condition of the data.

Specifically, the ToS field in the ICMP Time Exceeded message is checked, and if the ToS field is not zero, ToS field is decided to be rewritten, whereby the condition of the operation of a priority control function in the network can be detected (3603 in FIG. 36).

Now it has been shown that by the aforementioned processing, a change in a ToS field in a network can be estimated by using an ICMP Time Exceeded message.

### <Effect>

Next, effects of the sixth embodiment for practicing the present invention will be described.

According to the sixth embodiment for practicing the present invention, an operation of a priority control function in a network can be detected without introducing a special-purpose sever on the Internet, by estimating a change in a ToS field in a network based on information of an ICMP Time Exceeded message sent in return by a router, and thus, the object of the present invention is attained.

Next, a seventh embodiment for practicing the present invention will be described in detail with reference to the accompanying drawings.

### <Configuration>

While the sixth embodiment of the present invention addresses a method of estimating a ToS field, a method of estimating whether fragmentation has occurred will be described in the seventh embodiment of the present invention.

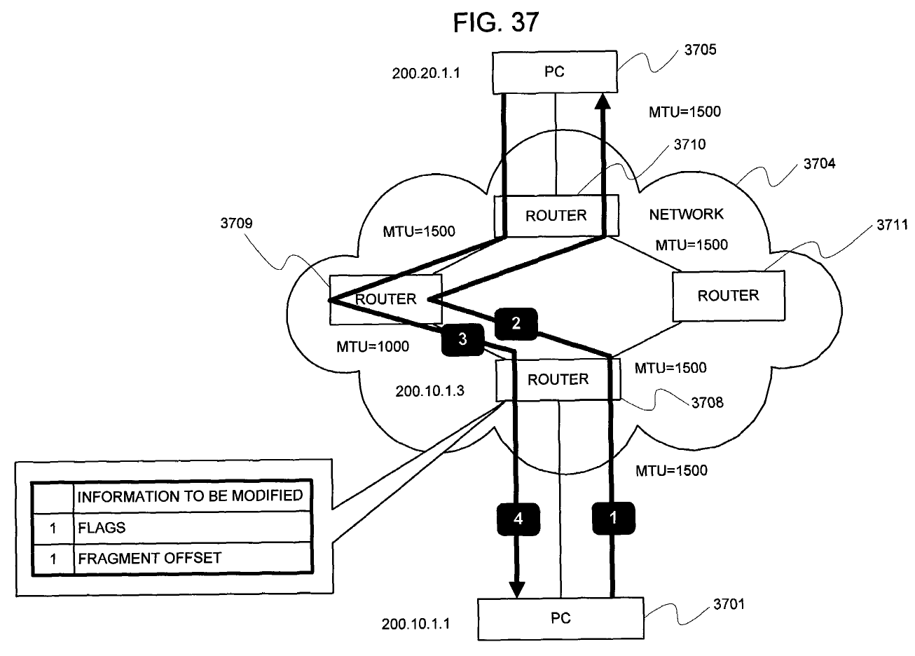

Referring to FIG. 37, the seventh embodiment of the present invention comprises a network 3704 such as the Internet, a PC 3701 operated by a user, any given PC 3705 on the Internet, and a router 3703 for controlling routing of packets. The network 3704 also comprises routers 3708-3711 for controlling routing of packets.

It is assumed that at the router 3708, fragmentation of a packet is applied to prevent the data size from exceeding an MTU of a line.

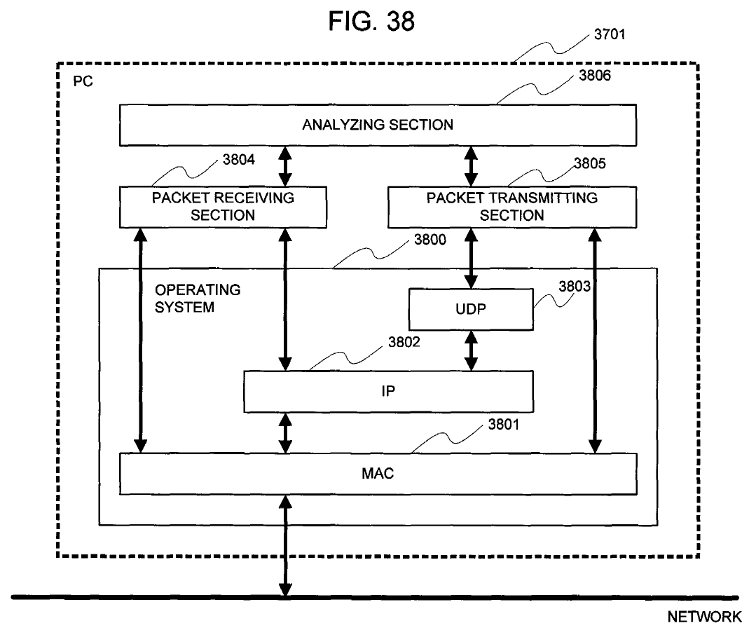

FIG. 38 shows the internal configuration of the PC 3701.

As shown in FIG. 38, the internal configuration of the PC 3701 is similar to that of the PC 3401 of the sixth embodiment of the present invention shown in FIG. 35. According to the seventh embodiment of the present invention, however, the processing executed by the analyzing section 3506 in FIG. 35 is modified to solve the aforementioned problem.

The analyzing section 3806 according to the seventh embodiment of the present invention detects occurrence of fragmentation made in a network with reference to an ICMP Time Exceeded message passed by the packet receiving section 3804, in addition to the processing of the analyzing section 3506 in FIG. 35.

Since other internal configurations are similar to those in the sixth embodiment shown in FIG. 35, description thereof will be omitted.

### <Operation>

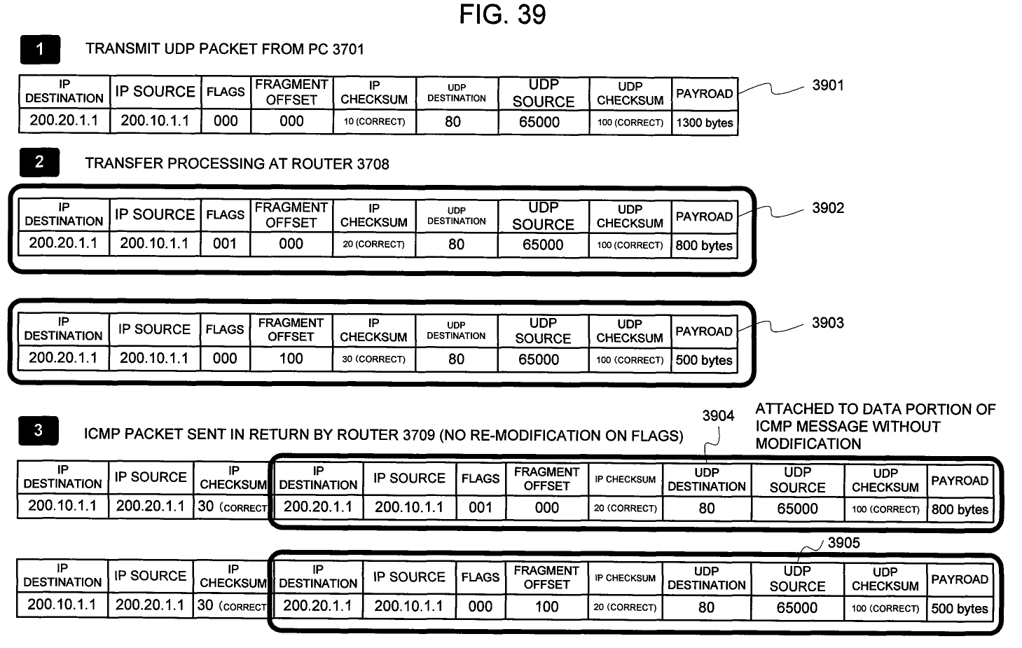

Since the processing of transmitting a packet having a small TTL value from the PC 3701 is similar to that in the sixth embodiment, description thereof will be omitted (3901 in FIG. 39).

In the following description of the operation, it is assumed that a UDP packet is transmitted from the PC 3701 as in the third embodiment; however, it would be obvious to those skilled in the art that a TCP packet may be transmitted in place of a UDP packet without any problem.

The packet size of a packet transmitted from the PC 3701 is assumed to be 1300 bytes (3901 in FIG. 39).

The data transmitted from the PC 3701 first undergoes fragmentation of an IP packet at a router 3708 shown in FIG. 37. In this example, the packet size is fragmented into two packets having 800 bytes and 500 bytes. The router 3708 that applied fragmentation sets a third bit of a flag field in the packet to one and sets a flag field in the last packet to zero. It also sets a fragment offset field to an offset value for the data.

The modification also entails recalculation of a checksum of the IP header (3902 and 3903 in FIG. 39). Moreover, TTL is rewritten from two to one at the router 3708.

The thus-modified packet is next delivered to the router 3709. At the router 3709, TTL is rewritten again from one to zero, and TTL now becomes zero upon which the packet is discarded. Then, the router 3709 sends an ICMP Time Exceeded message in return to the PC 3701 that is a sender of the packet. The ICMP Time Exceeded message is sent as a packet as shown in 3904 and 3905 in FIG. 39, whose data portion is attached with the packet received earlier by the router 3709 without modification.

On receipt of the ICMP packet from the router 3709, the PC 3701 takes it up to the analyzing section 3806 via the MAC section 3801, as in the sixth embodiment.

On receipt of the data portion of the header of the ICMP Time Exceeded message from the packet receiving section 3804, the analyzing section 3806 can detect whether fragmentation has occurred in the network with reference to the condition of the data.

Specifically, the fragment field and offset field in the ICMP Time Exceeded message are checked, and if any of these fields is not zero, fragmentation is decided to have occurred, whereby occurrence of fragmentation in the network can be detected (3904 and 3905 in FIG. 39).

Now it has been shown that by the aforementioned processing, occurrence of fragmentation in a network can be detected by using an ICMP Time Exceeded message.

### <Effect>

Next, effects of the seventh embodiment for practicing the present invention will be described.

According to the seventh embodiment for practicing the present invention, whether fragmentation has occurred in a network can be detected without introducing a special-purpose sever on the Internet, by estimating a condition of fragmentation in the network based on information of an ICMP Time Exceeded message sent in return by a router, and thus, the object of the present invention is attained.

Next, an eighth embodiment for practicing the present invention will be described in detail with reference to the accompanying drawings.

### <Configuration>

While the fifth embodiment of the present invention addresses a method of getting information required to communicate UDP packets between PC's, a method of getting information required to communicate TCP packets between PC's will be described in the eighth embodiment of the present invention.

Specifically, a method of estimating information required to communicate TCP packets between the PC's 401 and 407 of FIG. 4 will be described here.

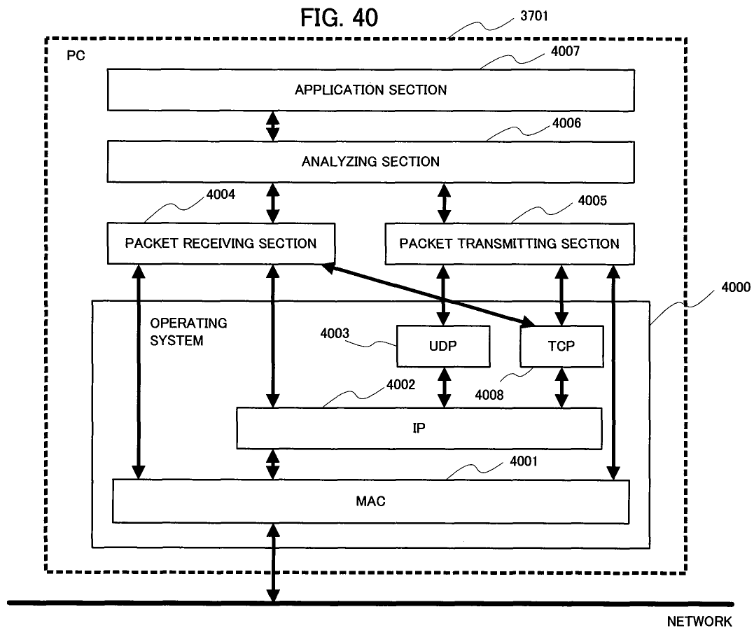

FIG. 40 shows the configuration of the eighth embodiment of the present invention. According to the eighth embodiment of the present invention, the processing executed by the analyzing section 3106, packet transmitting section 3105, and packet receiving section 3104 in FIG. 31 is modified, and a TCP section 4008 is included to solve the aforementioned problem.

An analyzing section 4006 in FIG. 40 notifies a sequence number of a TCP packet to a communication partner, in addition to the processing of the analyzing section 3106 in FIG. 31. It also receives an IP address and a port number of a NAT router, and a sequence number from a partner, and commands a packet transmitting section 4105 to transmit a TCP packet based on the information.

A TCP section 4008 appends a TCP header to the data passed by the packet transmitting section, and then passes it to an IP section 4002. The TCP section 4008 also removes a TCP header from the data passed by the IP section 4002, and then passes it to a packet receiving section 4004.

Since other configurations are similar to those in the fifth embodiment, description thereof will be omitted.

### <Operation>

Next, the operation of the eighth embodiment for practicing the present invention will be described in detail with reference to FIG. 40.

In the eighth embodiment, an IP address of a NAT router and a port number for a UDP packet are first estimated and information thereon are notified to a communication partner; since these processing are quite similar to those in the fifth embodiment, description thereof will be omitted. Hence, it is presupposed that an IP address of a NAT router attached to the communication partner and a port number for a UDP packet have been already known between the PC's 401 and 407 of FIG. 4 in the following description.

Next, the analyzing section 4006 in the PC's 401 and 407 commands the packet transmitting section 4005 to transmit a TCP SYN packet whose TTL is set to a small value to the NAT router attached to the communication partner. It should be noted that a smaller TTL value is desirable when network congestions are taken into account, although any TTL value that does not allow the packet to reach the PC 407 will work.

On receipt of the command to transmit a SYN packet from the analyzing section 4006, the packet transmitting section 4005 passes the data to the TCP section 4008 to perform processing of transmitting a SYN packet to a specified destination.

On receipt of the data, the TCP section 4008 appends thereto a TCP header whose destination port number is set to a port number of the NAT router that has been already got to generate a SYN packet. Both the PC's 401 and 407 thus transmit respective SYN packets, and at that time, a TCP sequence number assigned to a SYN packet is recorded. Here, the TCP sequence number of the SYN packet transmitted by the PC 401 is designated as X, and that of the SYN packet transmitted by the PC 407 is designated as Y. The TCP section 4008 passes the SYN packets to the IP section 4002.

On receipt of the SYN packet from the TCP section 4008, the IP section 4002 appends thereto an IP header whose IP destination address is set to an IP address of the NAT router, and passes it to the MAC section 4001.

On receipt of the packet from the IP section 4002, the MAC section 4001 appends thereto a MAC header, and transmits it to the transmission path.

The thus-transmitted SYN packet, however, have a small TTL value, it is discarded at a router on the way.

Next, the analyzing section 4006 in the PC's 401 and 407 notifies the TCP sequence number recorded earlier to the communication partner via a mail.

On receipt of the TCP sequence number from the communication partner via a mail, the analyzing section 4006 in the PC's 401 and 407 commands the packet transmitting section 4005 to transmit a SYN+ACK packet taking the TCP sequence number into account.

On receipt of the command to transmit a SYN+ACK packet from the analyzing section 4006, the packet transmitting section 4005 passes the data to the TCP section 4008 to perform processing of transmitting the SYN+ACK packet toward a specified destination.

On receipt of the data, the TCP section 4008 appends thereto a TCP header to generate a SYN+ACK packet, whose destination port number is set to a port number of the NAT router, and TCP sequence number and TCP confirmation response number are assigned with appropriate values. Now as for the SYN+ACK packet to be transmitted from the PC 401, its destination port number is set to the port number of the NAT router 406, TCP sequence number as X, and TCP confirmation response number as Y+1. On the other hand, as for the SYN+ACK packet to be transmitted from the PC 407, its destination port number is set to the port number of the NAT router 402, TCP sequence number as Y, and TCP confirmation response number as X+1. The TCP section 4008 of the PC's 401 and 407 passes such an SYN+ACK packet to the IP section 4002.

On receipt of the SYN+ACK packet from the TCP section 4008, the IP section 4002 appends thereto an IP header whose IP destination address is set to the IP address of the NAT router attached to the communication partner, and passes it to the MAC section 4001.

On receipt of the packet from the IP section 4002, the MAC section 4001 appends a MAC header thereto, and transmits it to the transmission path.

It should be noted here that a mapping table should be created in each NAT router by transmitting in advance a SYN packet before transmitting the SYN+ACK packet. Accordingly, the SYN+ACK packet transmitted from the PC's 401 and 407 is delivered to the communication partner instead of being discarded at the NAT router attached to the communication partner.

It should be noted here that in some types of NAT routers, the port number the NAT router opens for a UDP packet may be different from that the NAT router opens for a TCP packet. For example, the port number for a UDP packet is sometimes different by about one from that for a TCP packet. In such a case, if the destination TCP port number for a SYN packet or SYN+ACK packet is defined as a port number for a UDP packet as described above, the SYN+ACK packet is discarded at the NAT router because the port number does not match that in the mapping table. To accommodate such a condition, it is possible make modification such that a value of the port number for a UDP packet plus one is defined as the destination TCP port number for a SYN packet or SYN+ACK packet.

However, it should be understood that the aforementioned method of setting a destination port number is merely provided by way of example. It would be obvious to those skilled in the art by reviewing the present description that the method of setting a destination port number is implemented in any one of a wide variety of methods.

Next, on receipt of the SYN+ACK packet from the communication partner, the analyzing section 4006 in the PC's 401 and 407 commands the packet analyzing section 4005 to transmit an ACK packet.

On receipt of the command to transmit an ACK packet from the analyzing section 4006, the packet transmitting section 4005 passes the data to the TCP section 4008 to perform processing of transmitting an ACK packet to the specified destination.

On receipt of the data, the TCP section 4008 appends thereto a TCP header whose destination port number is set to the port number of the NAT router, and the TCP confirmation response number is set to an appropriate value to generate an ACK packet. Now as for the ACK packet to be transmitted from the PC 401, its destination port number is set to the port number of the NAT router 406, and TCP confirmation response number as Y+1. On the other hand, as for the ACK packet to be transmitted from the PC 407, its destination port number is set to the port number of the NAT router 402, and TCP confirmation response number as X+1. The TCP section 4008 of the PC's 401 and 407 passes such an ACK packet to the IP section 4002.

On receipt of the ACK packet from the TCP section 4008, the IP section 4002 appends thereto an IP header whose IP destination address is set to the IP address of the NAT router attached to the communication partner, and passes it to the MAC section 4001.

On receipt of the packet from the IP section 4002, the MAC section 4001 appends a MAC header thereto, and transmits it to the transmission path.

Such an ACK packet is delivered to the communication partner instead of being discarded at the NAT router attached to the communication partner. By the aforementioned processing, three-way handshake processing required to establish a TCP session is completed.

### <Effect>

Next, effects of the eighth embodiment for practicing the present invention will be described.

According to the eighth embodiment for practicing the present invention, even if a PC that serves as a communication partner is located downstream of a NAT router, information required to communicate a TCP packet can be estimated without introducing a special-purpose sever on the Internet, and thus, the object of the present invention is attained.

What is claimed is:

1. An estimating system for estimating information about apparatuses on a network, comprising:
a responding device for responding to an incoming information-collecting packet to send a control message in return; and
an estimating device for estimating information about the apparatuses on said network based on the control message from said responding device.

2. An estimating system according to claim 1, wherein said responding device is a device for responding to an information-collecting packet destined for a port number that is not in a standby status to send a control message indicating unreachable in return.

3. An estimating system according to claim 1, wherein said responding device is a device for sending a control message in return, in which said information-collecting packet is stored in a data section of a header of the message.

4. An estimating system according to claim 1, wherein said responding device is a device for responding to an information-collecting packet having information indicating a number of apparatuses that allow said information-collecting packet to pass being zero to send a control message in return indicating that said information-collecting packet is discarded.

5. An estimating system according to claim 1, wherein said estimating device is a device for estimating based on information indicating quality.

6. An estimating system according to claim 1, wherein said estimating device is a device for estimating based on information indicating that said information-collecting packet is fragmented.

7. An estimating system according to claim 1, wherein said estimating device is a device for estimating based on a checksum value.

8. An estimating system according to claim 7, wherein said estimating device is a device for estimating information about an apparatus that has modified an IP source address in a data section of said control message, based on an IP checksum value, and estimating information about an apparatus that has modified a source port number in the data section of said control message, based on a UDP checksum value or a TCP checksum value.

9. An estimating system according to claim 8, wherein said estimating device is a device for estimating information about an apparatus that has modified an IP source address in the data section of said control message, based on a UDP checksum value or a TCP checksum value.

10. An estimating system according to claim 7, wherein said estimating device is a device for estimating taking account of a result of a route tracing test for a network.

11. An estimating system according to claim 10, wherein said route tracing test is a survey test achieved by transmitting a plurality of information-collecting packets having mutually different numeric values in information indicating the number of apparatuses that allow passage.

12. An estimating system according to claim 10, wherein said route tracing test is a test for surveying the number of previously estimated apparatuses which are passed to reach a terminal.

13. An estimating system according to claim 10, wherein said route tracing test is a test for surveying the number of apparatuses that have been passed to reach an apparatus at a position of changeover between a private IP address and a global IP address.

14. An estimating system according to claim 1, wherein said estimating device is a device for notifying a result of estimation to a terminal on said network.

15. An estimating system according to claim 14, wherein said estimating device is configured to store, on receipt of a result of estimation from another terminal on said network, said result of estimation.

16. An estimating system according to claim 14, wherein said estimating device is a device for estimating regularity in assignment processing for port numbers of computers on said network based on a plurality of results of estimation.

17. An estimating system according to claim 14, wherein said estimating device is configured to notify said results of estimation to a communication partner via a mail or phone.

18. An estimating system according to claim 1, wherein said estimating device is a device for setting information indicating the number of apparatuses that allow said information-collecting packet to pass to a value such that the information will not reach a destination acquired based on said result of estimation, transmitting an SYN packet to said destination, and notifying a sequence number of said SYN packet to said destination.

19. An estimating system according to claim 18, wherein said estimating device is a device for transmitting, on receipt of the sequence number of said transmitted SYN packet, a response confirmation packet taking account of said sequence number.

20. An estimating system for estimating information about apparatuses on a network, wherein:
an error message or a control message stipulated by a communication protocol is used to estimate the information about the apparatuses on said network.

21. A terminal comprising:
a device for transmitting an information-collecting packet; and
an estimating device for estimating information about apparatuses on a network based on a control message transmitted in response to said information-collecting packet.

22. An estimating method of estimating information about apparatuses on a network, comprising:
a responding step of responding to an incoming information-collecting packet to send a control message in return;
a deciding step of deciding whether a received message is a control message sent in return in response to said information-collecting packet; and
an estimating step of, if the received message is decided to be the control message sent in return in response to said information-collecting packet as a result of said decision, estimating information about apparatuses on said network based on said control message.

23. An estimating method according to claim 22, wherein said responding step is a step of responding to an information-collecting packet destined for a port number that is not in a standby status to send a control message indicating unreachable in return.

24. An estimating method according to claim 22, wherein said responding step is a step of sending a control message in return, in which said information-collecting packet is stored in a data section of a header of the message.

25. An estimating method according to claim 22, wherein said responding step is a step of responding to an information-collecting packet having information indicating a number of apparatuses that allow said information-collecting packet to pass being zero to send a control message in return indicating that said information-collecting packet is discarded.

26. An estimating method according to claim 22, wherein said estimating step is a step of estimating based on information indicating quality.

27. An estimating method according to claim 22, wherein said estimating step is a step of estimating based on information indicating that said information-collecting packet is fragmented.

28. An estimating method according to claim 22, wherein said estimating step is a step of estimating based on a checksum value.

29. An estimating method according to claim 28, wherein said estimating step comprises the steps of:
estimating information about an apparatus that has modified an IP source address in a data section of said control message, based on an IP checksum value; and
estimating information about an apparatus that has modified a source port number or an IP address in the data section of said control message, based on a UDP checksum value or a TCP checksum value.

30. An estimating method according to claim 28, wherein said estimating step comprises:
a route tracing execution step of executing a route tracing test for the network; and
a detailed information estimating step of estimating information about the apparatuses taking account of a result of said execution.

31. An estimating method according to claim 30, wherein said route tracing execution step is a step of transmitting a plurality of information-collecting packets having mutually different numeric values in information indicating the number of apparatuses that allow passage.

32. An estimating method according to claim 30, wherein said route tracing execution step is a step of surveying the number of previously estimated apparatuses which are passed to reach an apparatus.

33. An estimating method according to claim 30, wherein said route tracing execution step is a step of surveying the number of apparatuses that have been passed to reach an apparatus at a position of changeover between a private IP address and a global IP address.

34. An estimating method according to claim 22, wherein said estimating step comprises a step of notifying a result of estimation to a terminal on said network.

35. An estimating method according to claim 34, wherein said estimating step comprises a step of, on receipt of a result of estimation from another terminal on said network, storing said result of estimation.

36. An estimating method according to claim 34, wherein said estimating step is a step of estimating regularity in assignment processing for port numbers of computers on said network based on a plurality of results of estimation.

37. An estimating method according to claim 34, wherein said estimating step comprises an estimating step of notifying said results of estimation to a terminal that serves as a communication partner via a mail or phone.

38. An estimating method according to claim 22, wherein said estimating step comprises a step of setting information indicating the number of apparatuses that allow said information-collecting packet to pass to a value such that the information will not reach a destination acquired based on said result of estimation, transmitting an SYN packet to said destination, and notifying a sequence number of said SYN packet to said destination.

39. An estimating method according to claim 38, wherein said estimating step comprises the steps of:
receiving the sequence number of said transmitted SYN packet; and
transmitting a response confirmation packet taking account of said received sequence number.

40. A program for an estimating system for estimating information about apparatuses on a network, causing said system to function as:
a responding device for responding to an incoming information-collecting packet to send a control message in return; and
an estimating device for estimating information about apparatuses on said network based on the control message from said responding device.

41. A program for a terminal, causing said terminal to function as:
a deciding device for deciding whether a received message is a control message sent in return in response to an information-collecting packet; and
an estimating device for, if the received message is decided to be the control message sent in return in response to said information-collecting packet as a result of said decision, estimating information about apparatuses on a network based on said control message.

42. A program for a system for estimating information about apparatuses on a network, causing said system to function as
a device for estimating information about the apparatuses on said network using an error message or a control message stipulated by a communication protocol.
